(19) United States
(12) Patent Application Publication
(10) Pub. No.: US 2010/0137578 A1
(43) Pub. Date: Jun. 3, 2010

(54) CELLULOSE ESTER FILM FOR OPTICAL USE, AND POLARIZING PLATE AND LIQUID CRYSTAL DISPLAY USING SUCH CELLULOSE ESTER FILM FOR OPTICAL USE

(75) Inventors: Emiko Kataoka, Tokyo (JP); Norio Miura, Kanagawa (JP); Takatugu Suzuki, Tokyo (JP); Kazuaki Nakamura, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 12/097,997

(22) PCT Filed: Nov. 24, 2006
(86) PCT No.: PCT/JP2006/323424

§ 371 Date: Jun. 18, 2008

(30) Foreign Application Priority Data
Dec. 21, 2005 (JP) 2005 367676

(51) Int. Cl. C08B 3/00

(52) U.S. Cl. 536/63

(57) ABSTRACT

Disclosed is a cellulose ester film for optical use which contains an ultraviolet absorbent and hardly suffers from retardation fluctuations. The cellulose ester film is excellent in spectral absorption property as an optical film. In addition, the cellulose ester film is free from coloration and has excellent transparency, which having sufficient ultraviolet absorption and excellent long-term light resistance. Also disclosed are a polarizing plate and liquid crystal display wherein high contrast is maintained by using such a cellulose ester film for optical use. Specifically disclosed is a cellulose ester film for optical use which is characterized by containing at least one compound represented by one of the general formulae 1-3. Also specifically disclosed are a polarizing plate and liquid crystal display using such a cellulose ester film for optical use.

### TECHNICAL FIELD

The present invention relates to a cellulose ester film which is employed for optical use and particularly to optical cellulose ester film which is usable as various functional films such as a protective film for a polarizing plate, a retardation film, or a viewing angle expanding film employed for liquid crystal display devices, various functional films such as an antireflective film employed in plasma displays, and various functional films employed in organic EL displays, and to UV absorbers which are applied thereto. The present invention relates, in more detail, to an optical cellulose ester film, which incorporates structure-specified UV absorbers, results in no unnecessary coloration, and exhibits excellent color reproduction, durability, and lightfastness, as well as a polarizing plate and a liquid crystal display device using the same.

### BACKGROUND

Optical films employed in the above technical fields exhibit problems in which, when exposed to radiation incorporating ultraviolet rays, they undergo accelerated decomposition to result in a decrease of strength, and simultaneously, film transparency is degraded due to discoloration. Consequently, with regard to optical films requiring high transparency, degradation due to ultraviolet rays is minimized via prior incorporation of CV absorbers such as benzotriazole based compounds, benzophenone based compounds, cyanoacrylate based compounds, or salicylic acid based compounds. However, since most of these conventional UV absorbers exhibit low solubility, they result in following various problems: Bleeding-out tends to occur, deposition on the film tends to occur, haze increases as transparency decreases, and further, the added amount decreases due to evaporation during any heating process, whereby ultraviolet ray absorbability is lowered and production processes result in staining.

Trials are described which overcome the above drawbacks in such a manner that polymerizable groups are introduced into UV absorbers, and the resulting UV absorbers are modified to polymers by undergoing homopolymerization or copolymerization (refer, for example, to Patent Documents 1-4). Further, examples are described in which as an optical film, ultraviolet ray-absorbing polymers are incorporated in the protective film for polarizing plates (refer, for example, to Patent Document 5).

The above-described ultraviolet ray-absorbing polymers have exhibited, to some extent, effects of minimizing bleeding-out, deposition, and evaporation. However, the resulting ultraviolet ray absorbability is insufficient, whereby in order to realize desired ultraviolet ray-absorbing performance, a large added amount is required. When a large amount of the above ultraviolet ray-absorbing polymers is added, problems occur in which the desired transparency is not realized due to insufficient compatibility with resins, the film itself is stained, and ultraviolet ray absorbability degrades during storage over an extended period. Consequently, it has been difficult to employ them as a practical optical film.

Characteristics required for optical film are sufficient blocking of 380 nm or shorter ultraviolet rays and sufficient transmission of 400 nm or longer ultraviolet rays. Various UV absorbers have been are proposed to meet these characteristics.

For example, in Japanese Patent Publication Open to Public Inspection (hereinafter referred to as JP-A) No. 2003-113317, described are UV absorbers which are prepared by substituting a 2′-hydroxyphenylbenzotriazole based UV absorbing agent with an amido group, a carbamoyl group, an ester group, or an acyloxy group, and it describes that by employing the polymers derived from monomers having specified substituents, desired effects are realized in which bleeding-out is retarded and process staining due to evaporation is reduced. However, no description is made with regard to a bis-body, a tris-body, and a tetra-body. Further, benzotriazole compounds are known as a compound to enhance weather resistance of polymer materials, but their optical use is not specifically detailed (refer, for example, to Patent Document 6).

### Patent Document 1: JP-A No. 60-38411

### Patent Document 2: JP-A No. 62-181360

### Patent Document 3: JP-A No. 3-281685

### Patent Document 4: JP-A No. 7-90184

### Patent Document 5: JP-A No. 6-148430

### Patent Document 6: JP-A No. 5-781517

### DISCLOSURE OF THE INVENTION

### Problems to be Solved by the Invention

In view of the foregoing, the present invention was achieved. An object of the present invention is to provide an optical cellulose ester film, which contains UV absorbers which exhibits excellent spectral absorption performance for optical film application, excellent transparency without coloration, sufficient ultraviolet ray absorbability, and excellent lightfastness over an extended period, and results in minimal variation of retardation, and a polarizing plate which maintains high contrast, and a liquid crystal display device using the same.

### Means to Solve the Problems

The above object has been attained by the following constitutions:

1. A cellulose ester film for optical use comprising at least one compound represented by Formulae 1, 2 or 3:

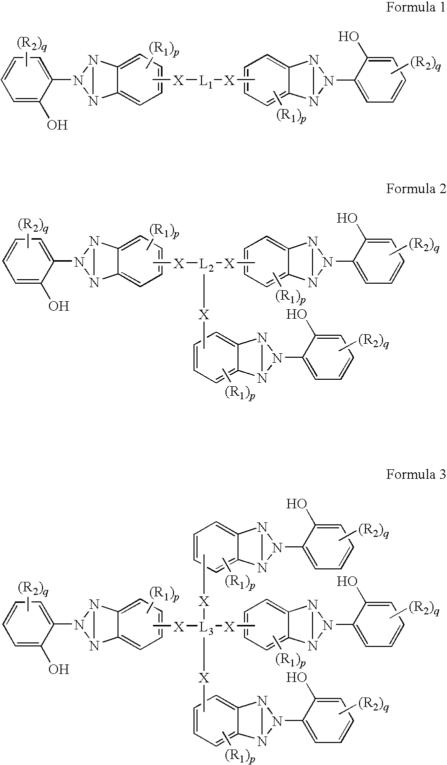

In Formulae 1 to 3, R₁ and R₂ each are a substituent; X is —COO—, —OCO—, NR₁₁CO—, —CONR₁₁—, —O—, —NR₁₂R₁₃—, —SO₂NR₁₄—, —NR₁₄SO₂—, —S—, or —SO₂—; L₁ is a divalent linking group; L₂ is a trivalent linking group; L₃ is a tetravalent linking group; R₁₁, R₁₂, R₁₃ and R₁₄ each are a hydrogen atom, an alkyl group, or an aryl group; p is an integer of 0 to 3; and q is an integer of 0 to 4.
2. The cellulose ester film, described in 1, wherein the compound represented by Formulae 1, 2 or 3 is further represented by Formulae 4, 5 or 6, respectively:

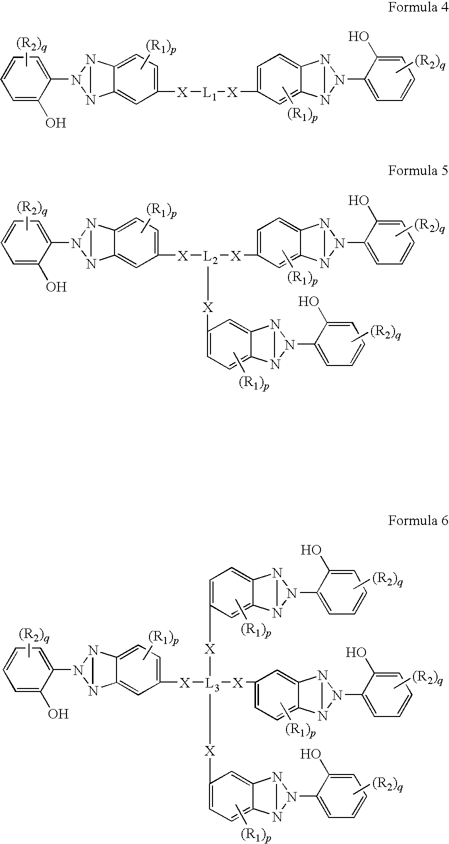

In Formulae 4 to 6, R₁ and R₂ each are a substituent; X is —COO—, —OCO—, NR₁₁CO—, —CONR₁₁—, —O—, —NR₁₂R₁₃—, —SO₂N₁₄—, —NR₁₄SO₂—, —S—, or —SO₂—; L₁ is a divalent linking group; L₂ is a trivalent linking group; L₃ is a tetravalent linking group; R₁₁, R₁₂, R₁₃ and R₁₄ each are a hydrogen atom, an alkyl group or an aryl group; p is an integer of 0 to 3; and q is an integer of 0 to 4.
3. The cellulose ester film, described in 1 or 2, wherein X in Formulae 1 to 6 is —COO—, NR₁₁CO—, or —CONR₁₁—, provided that R₁₁ is a hydrogen atom, an alkyl group or an aryl group.
4. The cellulose ester film, described in 2, wherein the compound presented by Formula 1 is further represented by Formula 4.
5. The cellulose ester film, described in 4, wherein X in Formula 4 is —COO—, —OCO—, NR₁₁CO—, or —CONR₁₁—, provided that R₁₁ is a hydrogen atom, an alkyl group or an aryl group.
6. The cellulose ester film described in any one of 1 to 5, in Formulae 1 to 5, L₁, L₂ and L₃ each are a linking group comprising an ether bond.
7. The polarizing plate comprising the cellulose ester film described in any one of 1 to 6.
8. The liquid crystal display comprising the cellulose ester film described in any one of 1 to 6.

### EFFECTS OF THE INVENTION

The present invention can provide an optical cellulose ester film which contains 1.7V absorbers, which exhibits excellent spectral absorption performance for film application, excellent transparency without coloration, sufficient ultraviolet ray absorbability, and excellent lightfastness over an extended period, and results in minimal variation of retardation, and a polarizing plate maintains high contrast and a liquid crystal display device using the same.

### PREFERRED EMBODIMENTS TO CARRY OUT THE INVENTION

The inventors of the present invention conducted diligent investigations for optical cellulose ester films incorporating UV absorbers, which was capable of solving the above problems. As a result, even though reasons were not understood in detail, by employing UV absorbers having a specified structure, it was discovered that that it was possible to prepare an optical cellulose ester film, which exhibited sufficient ultraviolet ray-absorbing performance such as excellent spectral absorption performance or excellent transparency without coloration, and exhibited excellent lightfastness over an extended period.

More specifically, as a result of such diligent investigations, it was discovered that when UV absorbers were employed, which formed bis-bodies, tris-bodies, or tetra-bodies jointed by linking groups from the benzotriazole ring of 2-hydroxyphenylbenzotriazole based UV absorbers were employed, excellent characteristics such as bleeding-out retardation or a decrease in process staining due to evaporation, or contrast enhancement as a liquid crystal display device were discovered, whereby the present invention was achieved.

The present invention will now be further detailed. (Compounds Represented by Formulae 1-6)

The present invention relates to the optical cellulose ester film which is characterized in incorporating at least one of the compounds represented by above Formulae 1-6.

In Formulae 1-6, R₁ and R₂ each represents a substituent which includes a halogen atom (for example, a fluorine atom, a chlorine atom, a bromine atom, and an iodine atom); an alkyl group (for example, a methyl group, an ethyl group, an isopropyl group, a hydroxyethyl group, a methoxymethyl group, a trifluoromethyl group, and a t-butyl group); an alkenyl group (for example, a vinyl group, an allyl group, and a 3-butene-1-yl group); an aryl group (for example, a phenyl group, a naphthyl group, a p-tolyl group, a and a p-chlorophenyl group); an alkoxy group (for example, a methoxy group, an ethoxy group, an isopropoxy group, and an n-butoxy group); an aryloxy group (for example, a phenoxy group); an acyloxy group (for example, an acetoxy group, a pivaloyloxy group, and a benzoyloxy group); an acyl group (for example, an acetyl group, a propanoyl group, and a butyloyl group); an alkoxycarbonyl group (for example, a methoxycarbonyl group and an ethoxycarbonyl group); an aryloxycarbonyl group (for example, a phenoxycarbonyl group); a carbamoyl group (for example, a methylcarbamoyl group, an ethylcarbamoyl group, and a dimethylcarbamoyl group); an amino group; an alkylamino group (for example, a methylamino group, an ethylamino group, and a diethylamino group); an anilino group (for example, an anilino group and an N-methylanilino group); an acylamino group (for example, an acetylamino group and a propionyl group); a hydroxyl group; a cyano group; a nitro group; a sulfonamide group (for example, a methanesulfonamide group and a benzenesulfonamide group); a sulfamoylamino group (for example, a dimethylsulfamoyl group); a sulfonyl group (for example, a methanesulfonyl group, a butanesulfonyl group, and a phenylsulfonyl group); a sulfamoyl group (for example, an ethylsulfamoyl group and a dimethylsulfamoyl group); a sulfonylamino group (for example, a methanesulfonylamino group and a benzenesulfonylamino group); a ureido group (for example, a 3-methylureido group and a 3,3-dimethylureido group); an imido group (for example, a phthalimido group); a silyl group (for example, a trimethylsilyl group, a triethylsilyl group, and a t-butyldimethylsilyl group); an alkylthio group (for example, a methylthio group and an n-butylthio group); an arylthio group (for example, a phenylthio group. Of these, preferred are the alkyl group and the aryl group.

Lᵢ represents a divalent linking group and examples thereof include an alkylene group (for example, methylene, ethylene, 2,2-dimethylpropylene, propylene, 1,4-cyclohexylane, dodecylene, hexadecylene, 2-ethylhexylene, and 2-hexyldecarene), an arylene group (for example, phenylene and naphthylene), —O—, —S—, and —NR₂₁R₂₂, as well as combinations thereof.

L₃ represents a trivalent linking group, and examples thereof include those having the following structure. In the formulae, * represents a linking point with X.

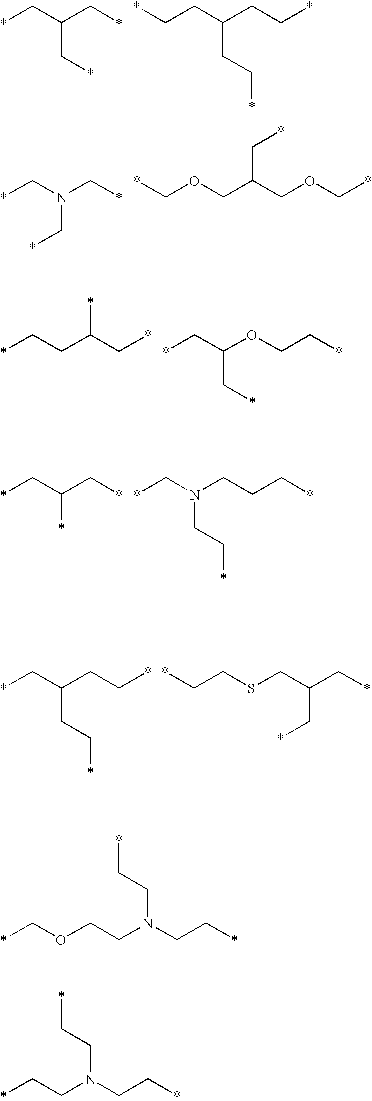

In the above formula, L₃ represents a tetravalent linking group, and includes those having the following structures. In the formulae, * represents a linking point with X.

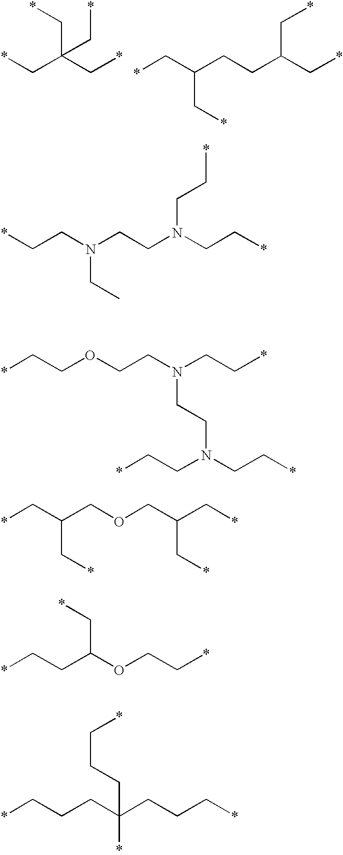

Of L₁, L₂, and L₃, L₁, namely Formula 1, and particularly Formula 4 are preferred in the present invention. With regard to L₁, L₂, and L₃ as a linking group, a linking group incorporating an ether bond is particularly preferred.

The compounds represented by Formulae I-6 will now be exemplified, however the present invention is not limited thereto.

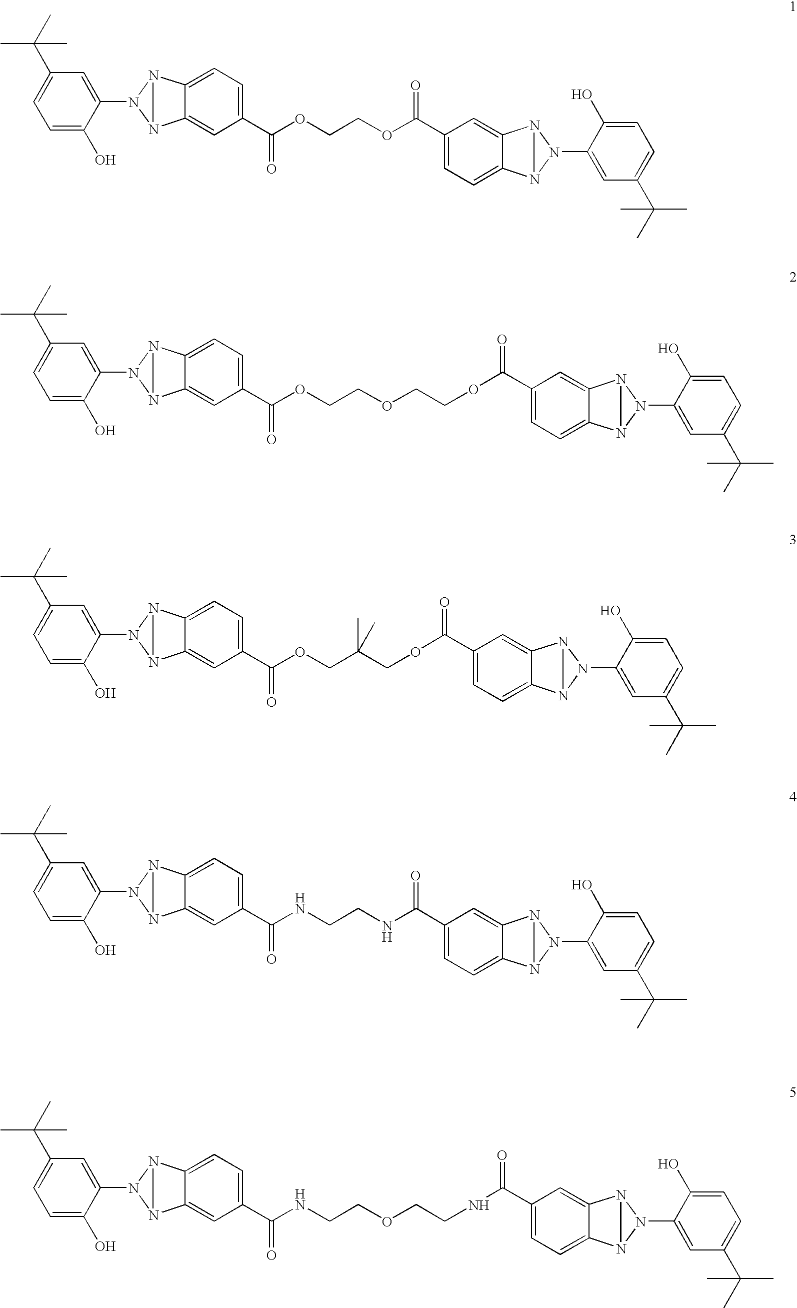

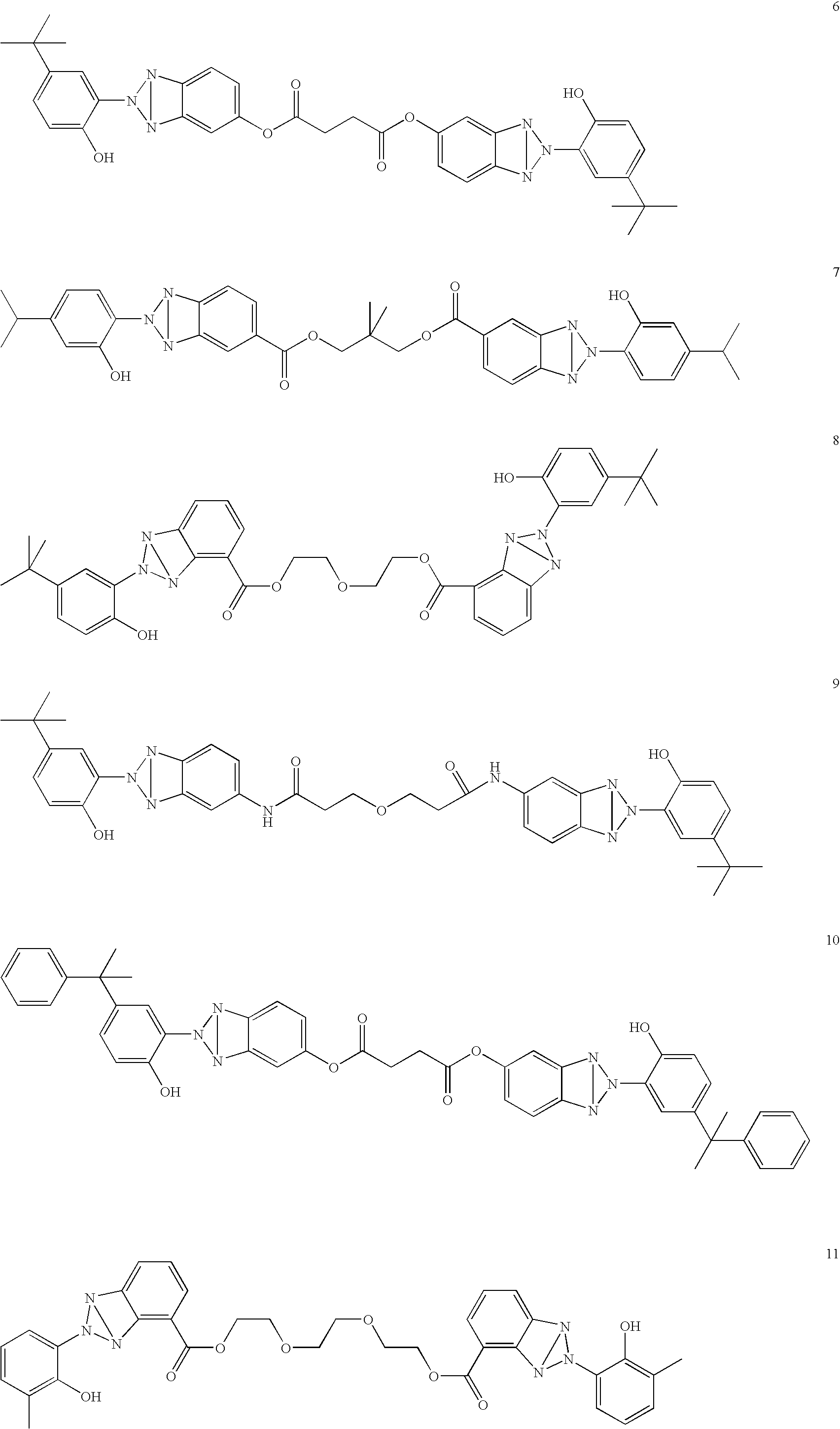

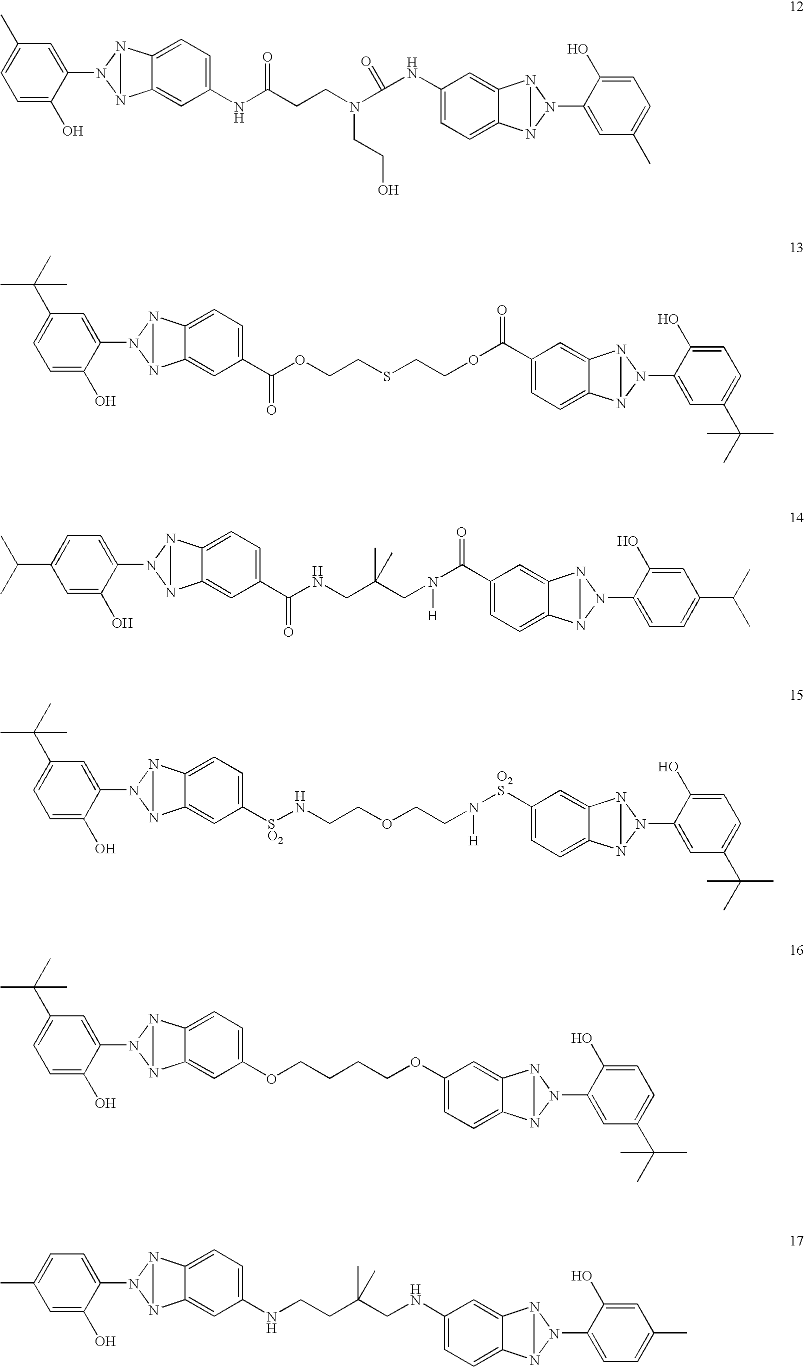

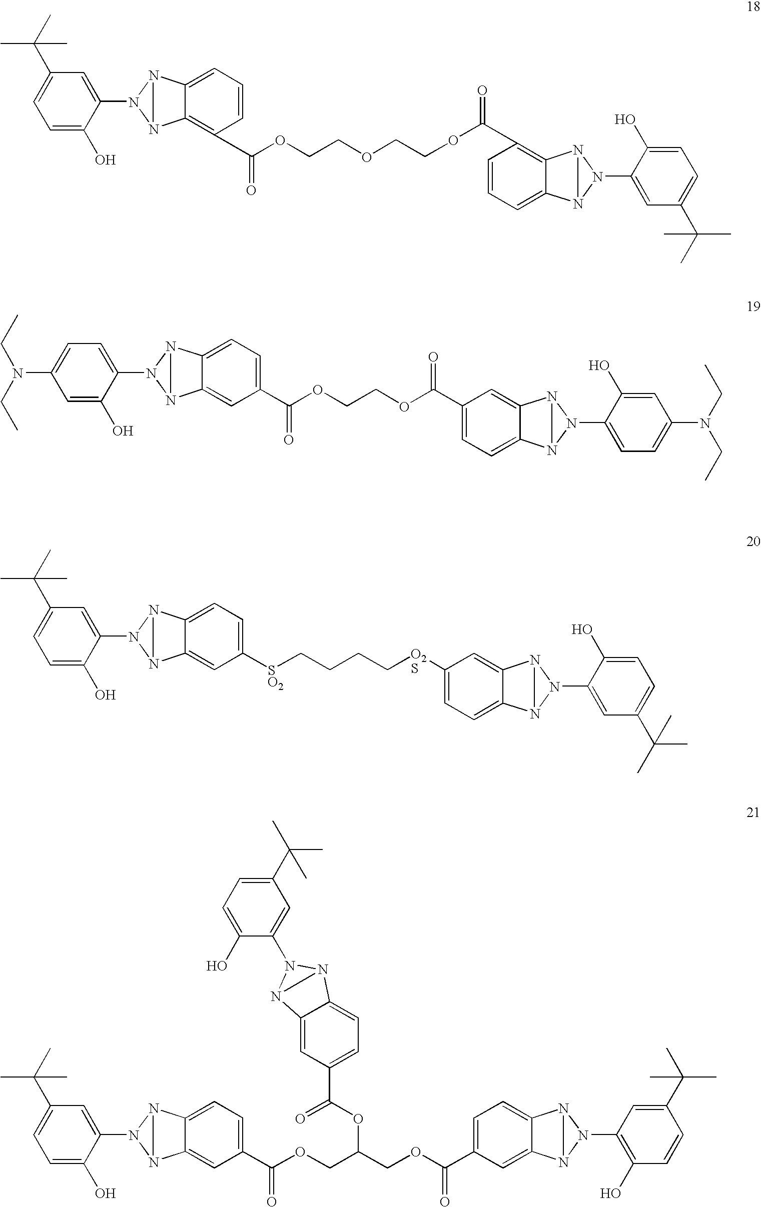

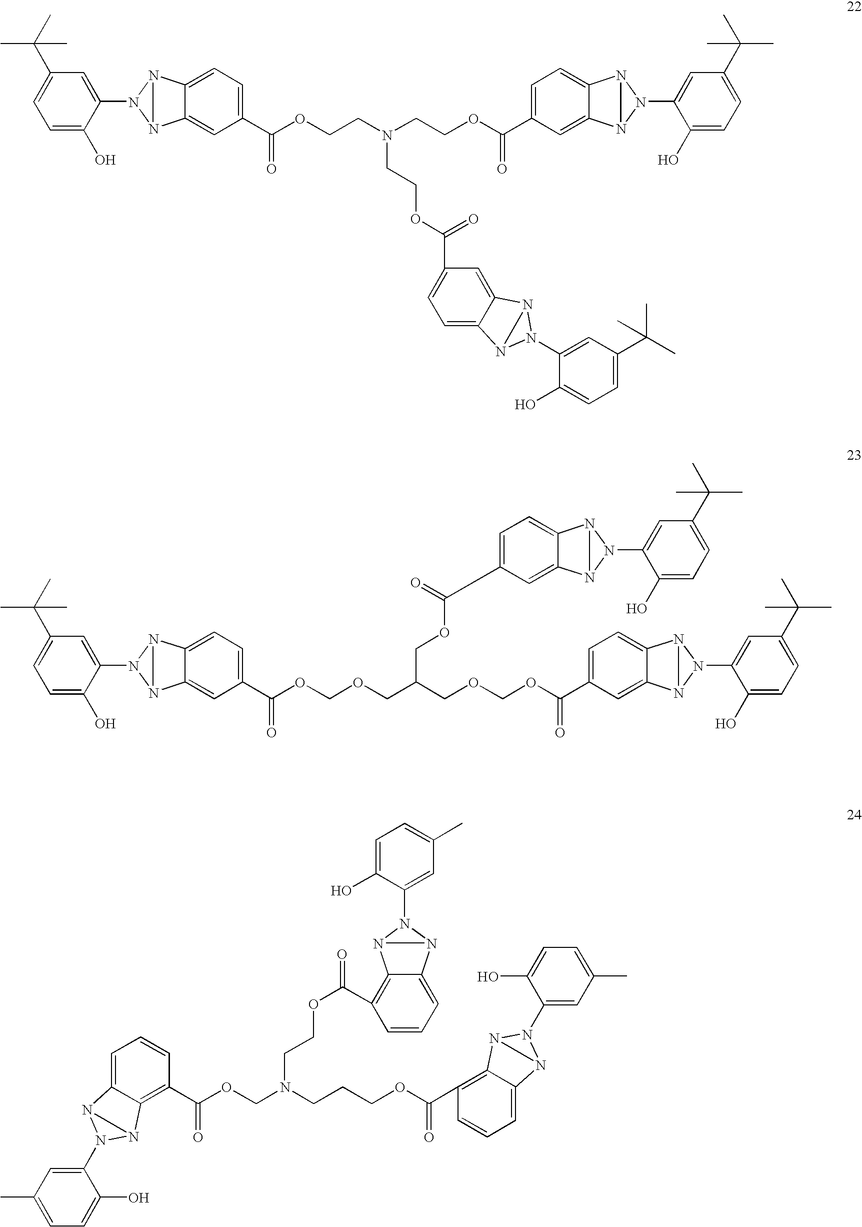

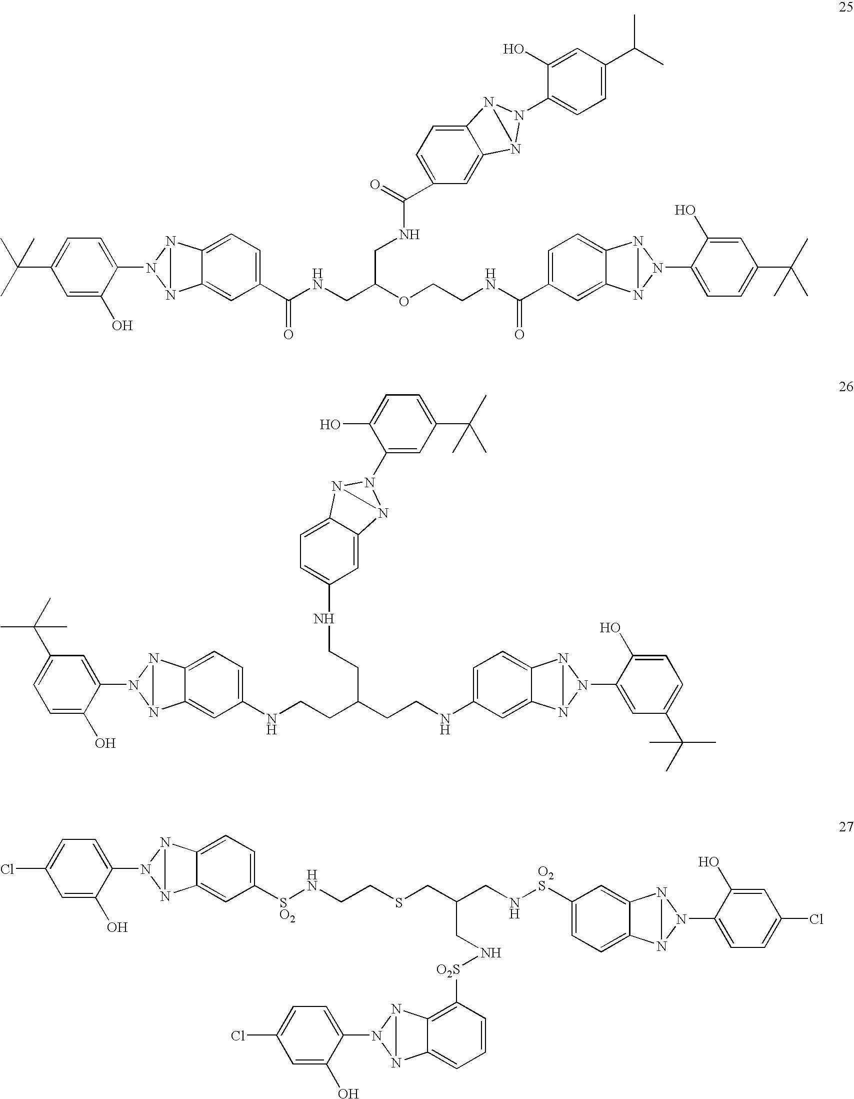

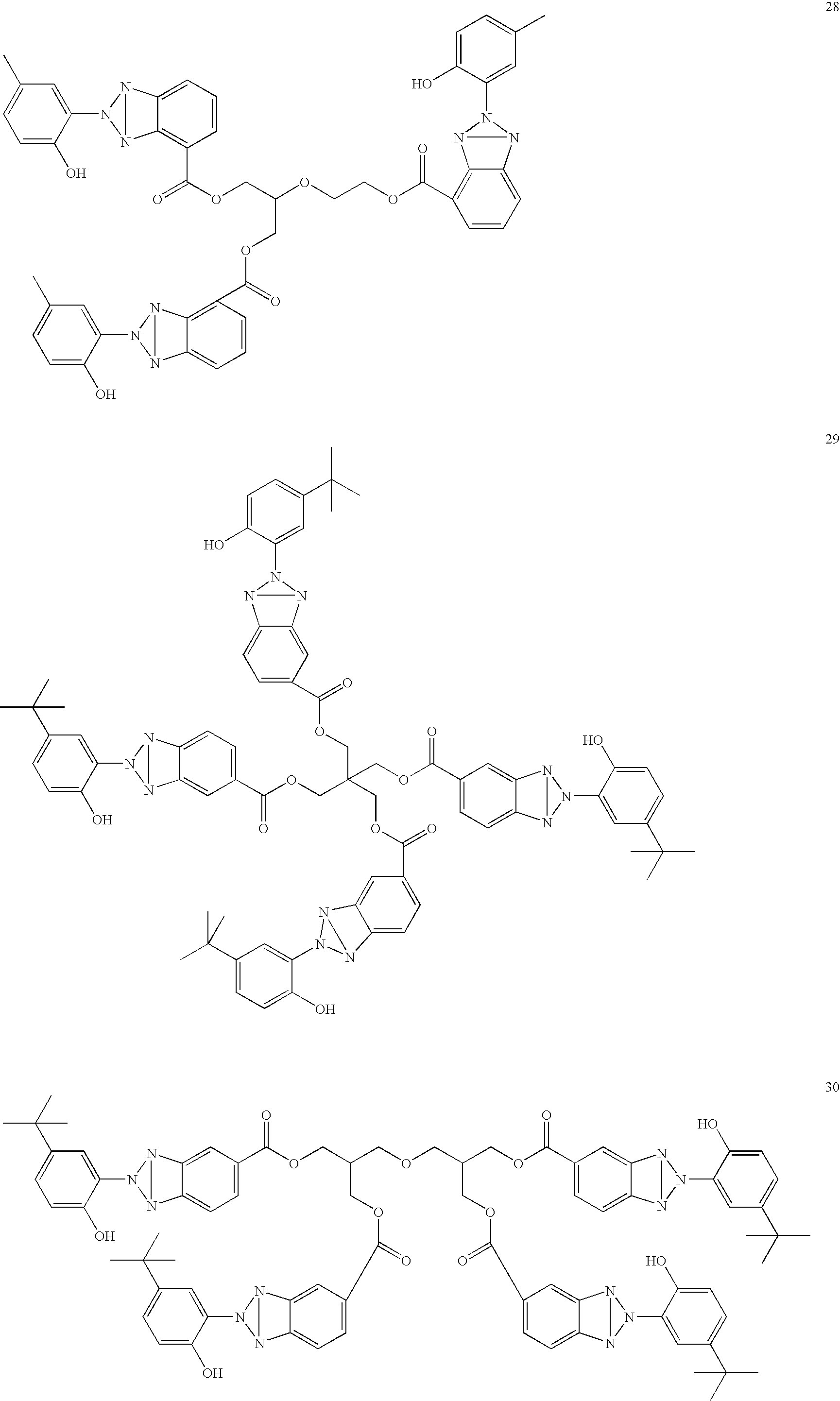

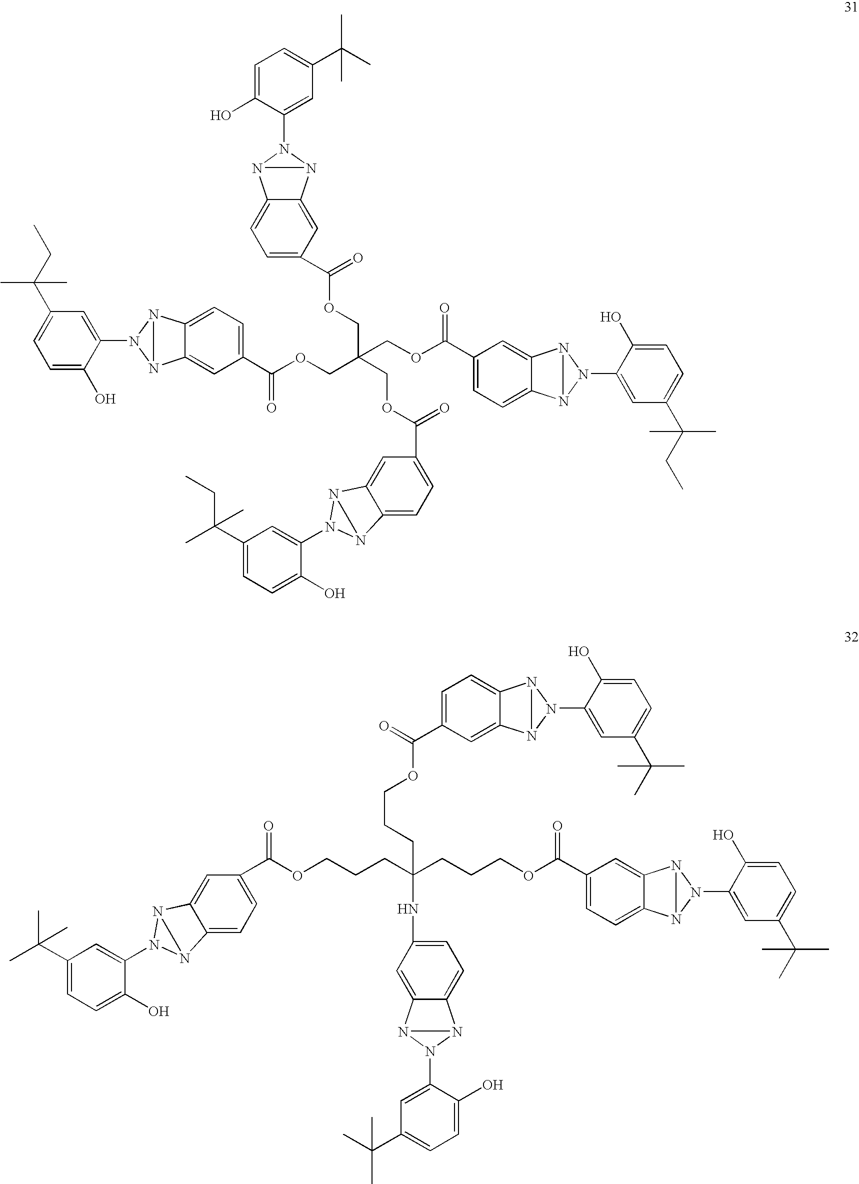

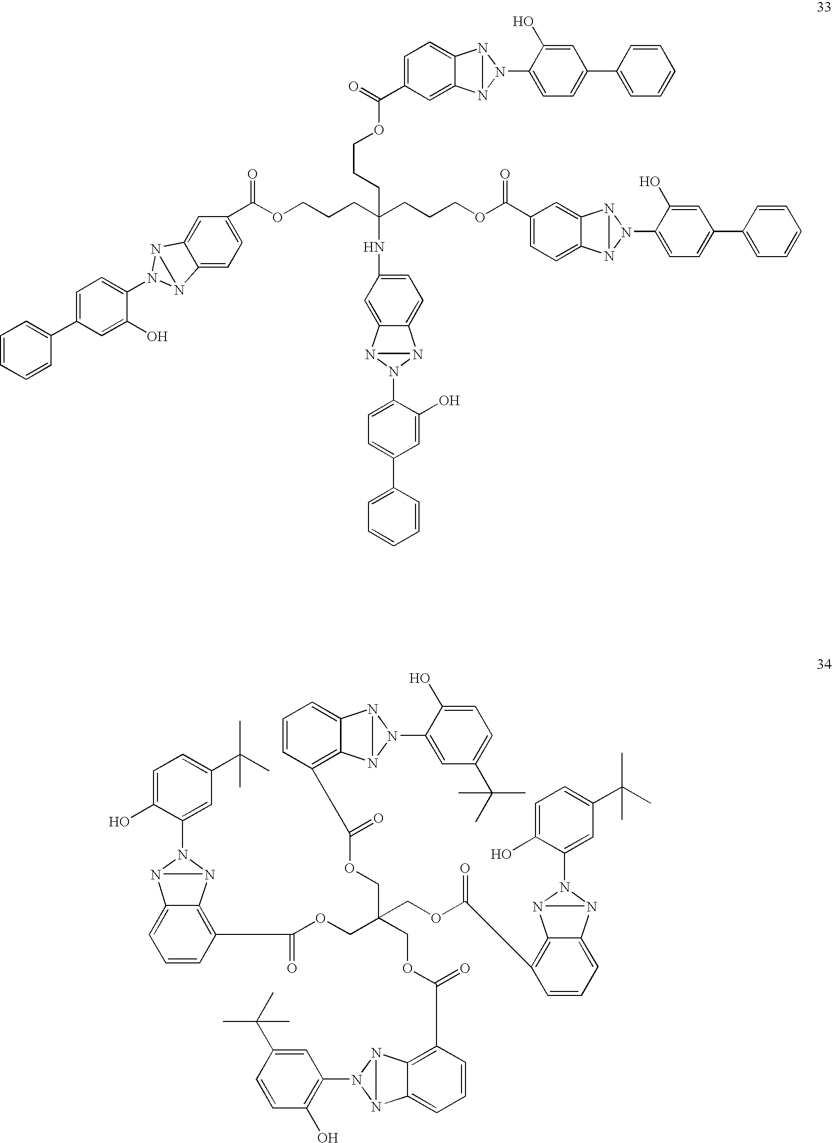

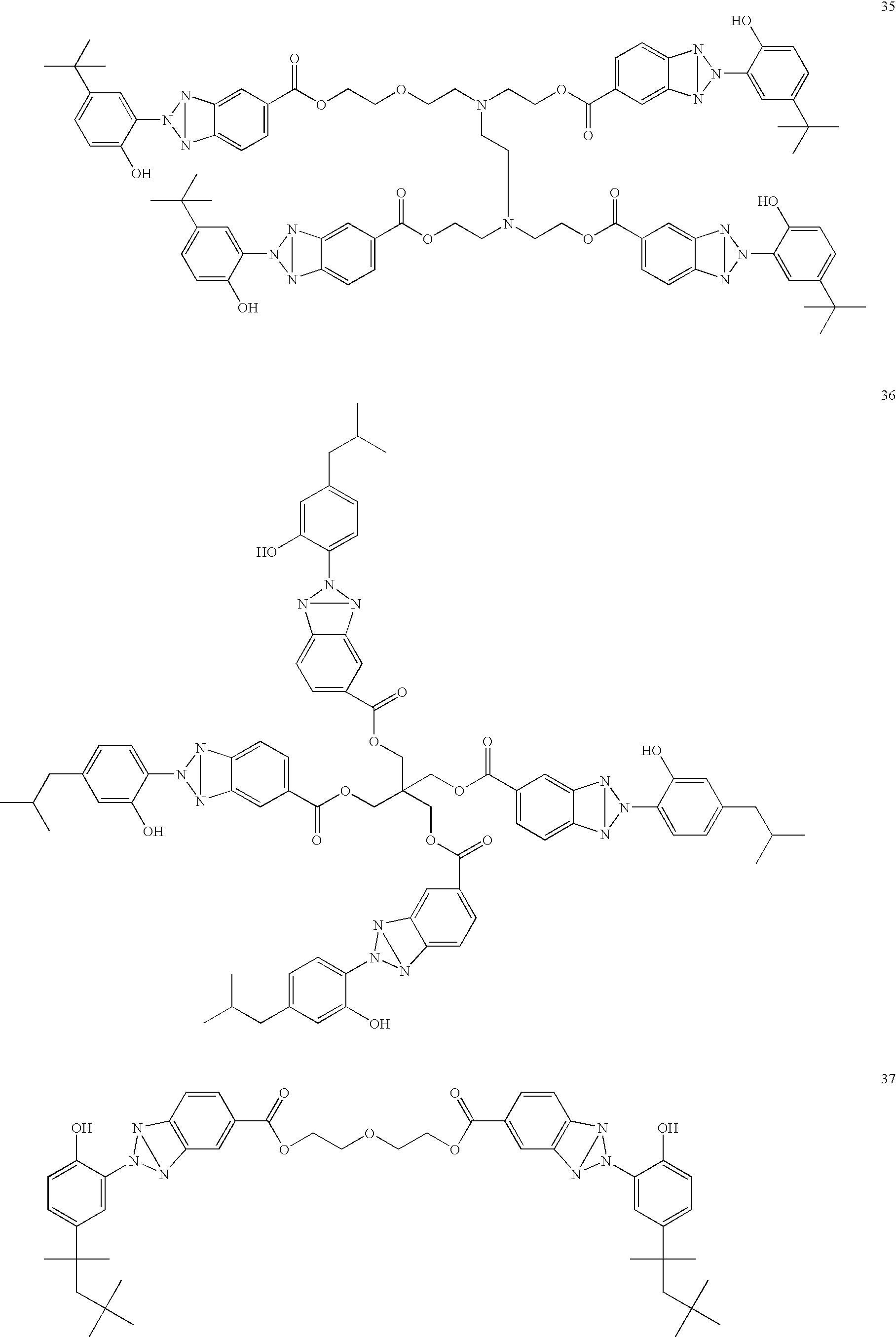

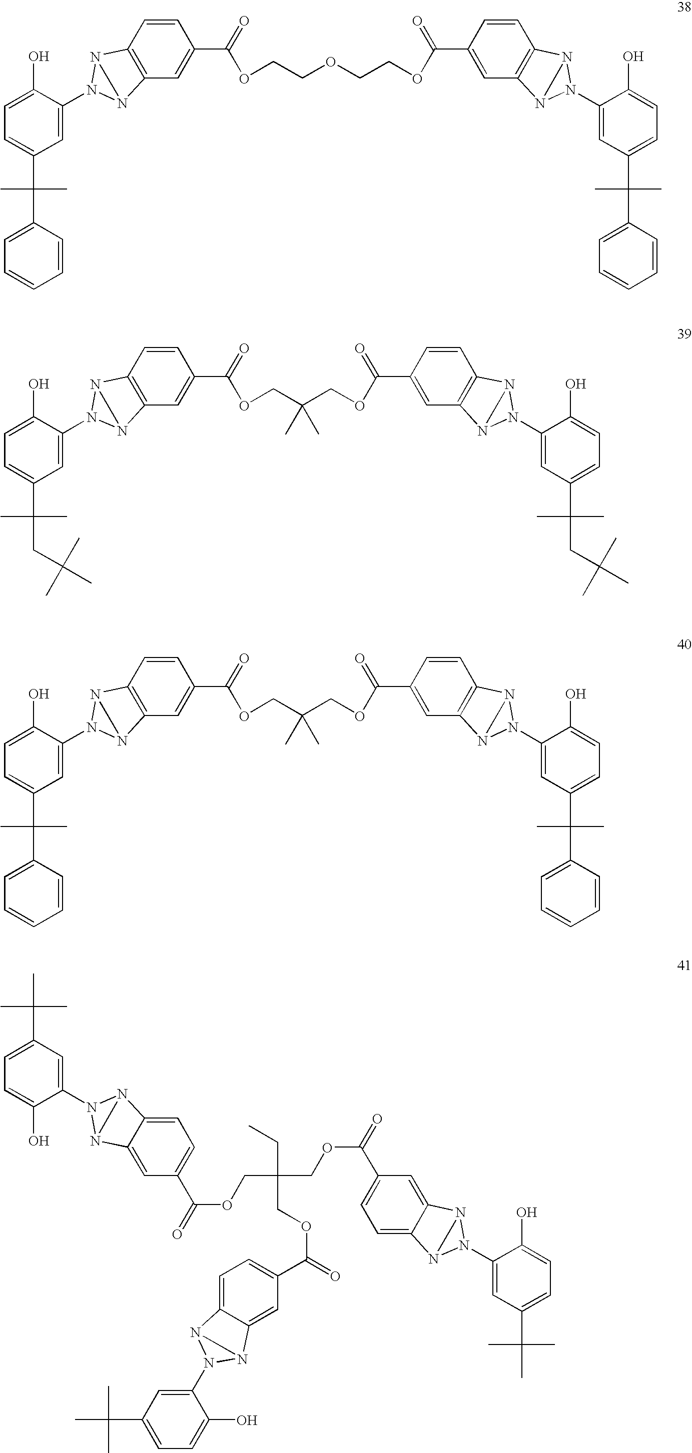

If desired, the compounds represented by Formulae 1-6, when blended with other transparent polymers, may be employed together with low molecular compounds, high molecular compounds, or inorganic compounds. For example, one of the preferred embodiments is that the compounds (namely, UV absorbers) represented by Formulae 1-6 and other UV absorbers or ultraviolet ray-absorbing polymers are simultaneously blended with other transparent polymers. Similarly, another preferred embodiment is that additives such as antioxidants, plasticizers, or fire retardants are simultaneously blended.

Addition methods of UV absorbers, according to the present invention, to the cellulose ester film (namely, the optical film) may include incorporation into the cellulose ester film or application onto the cellulose ester film. When incorporated into the cellulose ester film, direct incorporation may be usable.

The used amount of the compounds represented by Formulae 1-6 of the present invention varies depending on the types of compounds and used conditions. However, when employed as a UV absorber, the used amount is preferably 0.2-3.0 g per m² of cellulose ester film, is more preferably 0.4-2 g, but is most preferably 0.5-1.5 g. Further, to prevent liquid crystal degradation, preferred are those which exhibit excellent absorption performance of ultraviolet rays of a wavelength equal to 380 nm or shorter, while for excellent liquid display performance, preferred are those which result in minimal visible light absorption of a wavelength of equal to or longer than 300 nm. In the present invention, transmittance at a wavelength of 380 nm is specifically preferable to be at most 8%, is more preferably at most 4%, but is most preferably at most 1%.

Further, in the present invention, it is possible to simultaneously employ conventional UV absorbers, which are not particularly limited, and examples thereof include salicylic acid based UV absorbers (phenyl salicylate and p-tert-butyl salicylate); benzophenone based UV absorbers (2,4-dihydroxybenzophenone and 2,2′-dihydroxy-4,4′-dimethoxybenzophenone); benzotriazole based UV absorbers (2-(2′-hydroxy-3′-tert-butyl-5′-methylphenyl)-5-chlorobenzotriazole, 2-(2′-hydroxy-3′,5′-di-tert-butylphenyl)-5-chlorobenzotriazole, and 2-(2′-hydroxy-3,5′-di-tert-amyl-phenyl)benzotriazole); cyano acrylate based UV absorbers (2′-ethylhexyl-2-cyano-3,3-diphenyl acrylate and ethyl-2-cyano-3-(3′,4′-methylenedioxyphenyl)-acrylate); triazine based UV absorbers; the compounds described in JP-A Nos. 58-185677 and 59-149350; nickel complex salt based compounds; and inorganic powders.

As conventional UV absorbers employed together with the UV absorbers according to the present invention, preferred are the benzotriazole based and benzophenone based UV absorbers which exhibit high transparency and result in excellent effects to minimize degradation of polarizing plates and liquid crystal elements, as well as the benzotriazole based UV absorbers, which exhibit less unnecessary coloration, are particularly preferred.

In the present invention, further, conventional ultraviolet ray-absorbing polymers are usable. Conventional ultraviolet ray-absorbing polymers are not particularly limited, and examples thereof include a polymer which is prepared by homopolymerizing PUVA-93 (produced by Otsuka Chemical Co., Ltd.) and a polymer which is prepared by copolymerizing RUVA-93 together with other monomers. Specifically listed are PUVA-30M which is prepared by copolymerizing RUVA-93 with methyl methacrylate at a weight ratio of 3:7 (in terms of weight ratio) and PUVA-50M which is prepared by copolymerizing RUVA-93 with methyl methacrylate at a weight ratio of 5:5 (in terms of weight ratio).

### (Manufacturing Method of Optical Cellulose Film)

A manufacturing method of an optical cellulose film which is in the preferred embodiment of the present invention will now be described.

Film production processes employed to manufacture the optical cellulose film of the present invention include a solution casting method in which after dissolving cellulose ester in solvents, various additives are added to a solution in which a small amount of cellulose ester is dissolved and mixed employing an in-line, and subsequently, the resulting mixed solution is cast, and a melt casting method in which, without using solvents, cellulose ester is heated to a temperature at which it exhibits fluidity, and thereafter, fluid cellulose ester is cast. The heat-melt casting methods may further be divided, in more detail, to a melt extrusion casing method, a press casting method, an inflation method, an injection casting method, a blow casting method, and an orientation casting method. Of these, in order to prepare a cellulose ester film which exhibits excellent mechanical strength and surface accuracy, the melt extrusion method is superior. In this method, film constituting materials are heated to fluidity and thereafter, are extruded onto a drum or a looped belt to produce the film. Of these, preferred as a film producing process is the heat melt casting method.

### (Cellulose Esters)

Preferably employed as the cellulose esters used in the present invention are lower fatty acid eaters of cellulose.

Lower fatty acids in lower fatty acid esters of cellulose esters, as described herein, refer to fatty acids having at most 6 carbon atoms. Examples of lower fatty acid esters include cellulose acetate, cellulose propionate, cellulose butyrate, as well as mixed fatty acid esters such as cellulose acetate propionate or cellulose acetate butyrate, described in JP-A Nos. and 10-45804, 8-231761, and U.S. Pat. No. 2,319,052. Cellulose esters at a total substitution degree of 2.55-2.85 are preferably employed.

Of the above fatty acids, preferably employed are cellulose acetate and cellulose acetate propionate. In the case of the cellulose ester film according to the present invention, in view of film strength, specifically, those of a degree of polymerization of 250-400 are preferably employed.

The optical cellulose ester film of the present invention at a degree of the total substitution of 2.5-3.0 is preferably employed, but the same at a degree of the total substitution of 2.55-2.85 is more preferably-employed. When the degree of the total substitution is at least 2.55, the mechanical strength of film incorporating UV absorbers represented by Formulae 1-6 according to the present invention increases, while when it is at most 2.85, the solubility of cellulose ester is enhanced and generation of foreign matter is reduced, so that both cases are more preferred.

In the case of cellulose acetate propionate, the following ranges are preferably employed:

2.5≦X+Y≦2.9 Formula (I)

0.1≦X≦2.0 Formula (II)

wherein X represents the degree of substitution by an acetyl group, while Y represents the degree of substitution by a propionyl group.

Of these, it is preferable that 1.0≦X≦2.5 and 0.5≦Y≦2.5 are maintained.

Cellulose esters synthesized from cotton linter, cellulose esters synthesized from wood pulp, and cellulose esters synthesized from other materials may be employed individually or in combinations.

### (Plasticizers)

It is possible to incorporate plasticizers into the optical cellulose ester film of the present invention. In view of modified film quality such as enhancement in mechanical properties, creation of flexibility and water resistance, or decrease in water vapor permeability, it is preferable that commonly known plasticizers are added. Further, the melt extrusion method realizes a purpose to lower the melting temperature of film constituting materials than the glass transition temperature of individually employed cellulose ester by the addition of plasticizers and a purpose capable of lowering the viscosity of film constituting materials incorporating plasticizers than that of cellulose ester at the same heating temperature. Melting temperature of the film constituting materials, as described herein, refers to the temperature at which fluidity of the above heated materials results.

When only cellulose ester is used, at a temperature lower than its glass transition temperature, no fluidity results to enable formation of film. However, at temperature equal to or higher than the glass transition temperature, the elastic modulus or the viscosity is lowered via heat absorption, resulting in fluidity. In order to melt film constituting materials, it is preferable that to realize the above purposes, added plasticizers exhibit the melting point or the glass transition temperature which is lower than the glass transition point of the cellulose ester. Further, ester based plasticizers composed of polyhydric alcohol and univalent carboxylic acid, and of polyvalent carboxylic acid and monohydric alcohol are more preferred due to their higher compatibility with cellulose esters.

In the present invention, employed are both of ester based plasticizers composed of polyhydric alcohol and univalent carboxylic acid and ester based plasticizers composed of polyvalent carboxylic acid and monohydric alcohol or either of them.

Specifically listed as ethylene glycol based plasticizers which belong to polyhydric alcohol ester based ones are ethylene glycol alkyl ester based plasticizers such as ethylene glycol diacetate or ethylene glycol butyrate; ethylene glycol cycloalkyl ester based plasticizers such as ethylene glycol dicyclopropyl carboxylate or ethylene glycol dicyclohexyl carboxylate; and ethylene glycol aryl ester based plasticizers such as ethylene glycol dibenzoate or ethylene glycol di-4-methyl benzoate. These alkylate groups, cycloalkylate groups, and arylate groups may be the same or different, and may be further substituted. Further, the alkylate group, the cycloalkylate group, and the arylate group may be mixed, and these substituents may be combined via a covalent bond. Still further, the ethylene glycol portion may be substituted, and a partial structure of ethylene glycol ester may be a part of the polymer or may be regularly subjected to pendant, and further may be introduced into a part of the molecular structure of additives, such as antioxidants, acid scavengers, or UV absorbers.

Specifically listed as glycerin ester based ethylene plasticizers which belong to polyhydric alcohol ester based ones are glycerin alkylester such as triacetin, tributyrin, glycerin diacetate caprylate, or glycerin oleate propionate; glycerin cycloalkyl ester such as glycerin tricyclopropyl carboxylate, or glycerin tricyclohexyl carboxylate; glycerin aryl ester such as glycerin tribenzoate or glycerin 4-methylbenzoate; diglycerin alkyl ester such as diglycerin tetraacetate, diglycerin tetrapropionate, diglycerin acetate tricaprylate, or diglycerin tetralaurate; diglycerin cycloalkyl ester such as diglycerin tetracyclobutyl carboxylate or diglycerin tetracyclopentyl carboxylate; and diglycerin aryl ester such as diglycerin tetrabenzoate or diglycerin 3-methylbenzoate. These alkylate groups, cycloalkylate groups, and arylate groups may be the same or different, and may be further substituted. Further, the alkylate group, the cycloalkylate group, and the arylate group may be mixed, and these substituents may be combined via a covalent bond. Further, the glycerin and diglycerin portion may be substituted, and a partial structure of glycerin ester and diglycerin ester may be a part of the polymer or may be regularly subjected to pendant, and still further may be introduced into a part of the molecular structure of additives such as antioxidants, acid scavengers, or UV absorbers.

Other than the above, specific examples of polyhydric alcohol ester based plasticizers include the polyhydric alcohol ester based ones described in paragraphs 30-33 of JP-A No. 2003-12823.

These alkylate groups, cycloalkylate groups, and arylate groups may be the same or different, and may be further substituted. Still further, the alkylate group, the cycloalkylate group, and the arylate group may be mixed, and these substituents may be combined via a covalent bond. Further, the polyhydric portion may be substituted, and a partial structure of polyhydric alcohol may be a part of the polymer or may be regularly subjected to pendant, and further may be introduced into a part of the molecular structure of additives such as antioxidants, acid scavengers, or UV absorbers.

Of the above ester based plasticizers composed of polyhydric alcohol and univalent carboxylic acid, preferred are alkyl polyhydric alcohol aryl esters, and specific compounds thereof include the above ethylene glycol dibenzoate, glycerin tribenzoate, and diglycerin tetrabenzoate, as well as Exemplified Compound 1.6 described in paragraph 32 of JP-A No. 2003-12823.

Specifically listed as dicarboxylic acid ester based ethylene plasticizers which belong to polyvalent carboxylic acid ester based ones are alkyldicarboxylic acid alkyl ester based plasticizers such as dodecyl malonate (C1), dioctyl adipate (C4), or dibutyl sebacate (C8); alkyldicarboxylic acid cycloalkyl ester based plasticizers such as dicyclopentyl succinate or dicyclohexyl adipate; alkyldicarboxylic acid aryl ester based plasticizers such as diphenyl succinate or di4-methylphenyl glutarate; cycloalkyldicarboxylic acid alkyl ester based plasticizers such as dihexyl-1,4-cyclohexane dicarboxylate or didecylbicyclo[2.2.1]heptane-2,3-dicarboxylate; cycloalkyldicarboxylic acid cycloalkyl ester based plasticizers such as dicyclohexyl-1,2-cyclobutane dicarboxylate or dicyclopropyl-1,2-cyclohexxyl dicarboxylate; cycloalkyldicarboxylic acid aryl ester based plasticizers such as diphenyl-1,1-cyclopropyl dicarboxylate or di-2-naphthyl-1,4-cyclohexane dicarboxylate; aryldicarboxylic acid alkyl ester based plasticizers such as diethyl phthalate, dimethyl phthalate, dioctyl phthalate, dibutyl phthalate, or di-2-ethylhexyl phthalate; aryldicarboxylic acid cycloalkyl ester based plasticizers such as dicyclopropyl phthalate or dicyclohexyl phthalate; and aryldicarboxylic acid aryl ether based plasticizers such as diphenyl phthalate, di-4-methylphenyl phthalate. These alkoxy group and cycloalkoxy group may be the same or different. One substitution may be acceptable, and these substituents may be further substituted. The alkyl group, and the cycloalkyl group may be mixed, and these substituents may be combined via a covalent bond. Further, polymers such as a dimer, a trimer, or a tetramer may be acceptable. Further, a partial structure of phthalic acid ester may be a part of the polymer or may be regularly subjected to pendant, and further may be introduced into a part of the molecular structure of additives such as antioxidants, acid scavengers, or UV absorbers.

The added amount of ester based plasticizers, composed of polyhydric alcohol and univalent carboxylic acid, and ester based plasticizers, composed of polyvalent carboxylic acid and monohydric alcohol, is commonly 0.1-50 parts by weight with respect to 100 parts by weight of the cellulose ester, is preferably 1-30 parts by weight, but is more preferably 3-15 parts by weight.

Specifically listed as other polyvalent carboxylic acid ester based plasticizers are alkyl polyvalent carboxylic acid alkyl ester based plasticizers such as tridodecyl tricarbarate or tributyl-meso-butane-1,2,3,4-tetracarboxylate; alkyl multivalent carboxylic acid cycloalkyl ester based plasticizers such as tricyclohexyl tricarbarate or tricyclopropyl-2-hydroxy-1,2,3-propane tricarboxylate; alkyl polyvalent carboxylic acid aryl ester based plasticizers such as triphenyl-2-hydroxy-1,2,3-propane tricarboxylate or tetra3-methylphenyltetrahydrofurane-2,3,4,5-tetracarboxylate; cycloalkyl polyvalent carboxylic acid alkyl ester based plasticizers such as tetrahexyl-1,2,3,4-cyclobutane tetracarboxylate or tetrabutyl-1,2,3,4-cyclopentane tetracarboxylate; cycloalkyl polyvalent carboxylic acid cycloalkyl ester based plasticizers such as tetracyclopropyl-1,2,3,4-cyclobutane tetracarboxylate or tricyclohexyl-1,3,5-cyclohexyl tricarboxylate; cycloalkyl polyvalent carboxylic acid aryl ester based plasticizers such as triphenyl-1,3,5-cyclohexyl tricarboxylate or hexa-4-methylphenyl-1,2,3,4,5,6-cyclohexyl carboxylate; aryl polyvalent carboxylic acid alkyl ester based plasticizers such as tridodecylbenzene-1,2,4-tricarboxylate or tetraoctylbenzene-1,2,4,5-tetracarboxylate; aryl polyvalent carboxylic acid cycloalkyl ester based plasticizers such as tricyclopentylbenzene-1,3,5-tricarboxylate or tetracycloxylbenzene-1,2,3,5-tetracarboxylate; and aryl polyvalent carboxylic acid aryl ester based plasticizers such as triphenylbenzene-1,3,5-tetracarboxylate or hexa-4-methylphenylbenzene-1,2,3,4,5,6-hexacarboxylate. These alkoxy group and cycloalkoxy group may be the same or different. One substitution may be acceptable, and these substituents may be further substituted. The alkyl group, and the cycloalkyl group may be mixed, and these substituents may be combined via a covalent bond. Further, the aromatic ring of phthalic acid may be substituted and may include polymers such as a dimer, a trimer, or a tetramer. Still further, the partial structure of phthalic acid ester may be a part of the polymer or may be regularly subjected to pendant, and further may be introduced into a part of the molecular structure of additives such as antioxidants, acid scavengers, or UV absorbers.

Of the above ester based plasticizers composed of polyvalent carboxylic acid and monohydric alcohol, preferred is alkyldicarboxylic acid alkyl ester and specifically includes the above dioctyl adipate.

As other plasticizers employed in the present invention, listed are phosphoric acid ester based plasticizers and polymer plasticizers.

Specifically listed as the phosphoric acid ester based plasticizers are phosphoric acid alkyl esters such as triacetyl phosphate or tributyl phosphate; phosphoric acid cycloalkyl esters such as tricyclopentyl phosphate or cyclohexyl phosphate; and phosphoric acid aryl esters such as triphenyl phosphate, tricresyl phosphate, cresylphenyl phosphate, octyldiphenyl phosphate, diphenylbiphenyl phosphate, trioctyl phosphate, tributyl phosphate, trinaphthyl phosphate, trixylyl phosphate, or trisorthobiphenyl phosphate. These substituents may be the same or different, and may be further substituted. The alkyl group, the cycloalkyl group, and the aryl group may be mixed, and these substituents may be combined via a covalent bond.

Further, phosphoric acid esters are listed, which includes alkylenebis(dialkyl phosphates) such as ethylenebis(dimethyl phosphate) or butylenebis(diethyl phosphate); alkylenebis(diaryl phosphates) such as ethylenebis(diphenyl phosphate) or propylenebis(dinaphthyl phosphate); arylenebis(dialkyl phosphates) such as phenylenebis(dibutyl phosphate) or biphenylenebis(dioctyl phosphate); and arylenebis(diaryl phosphates) such as phenylenebis(diphenyl phosphate) or naphthylenebis(ditolyl phosphate). These substituents may be the same or different, and may be further substituted. The alkyl group, the cycloalkyl group, and the aryl group may be mixed, and these substituents may be combined via a covalent bond.

Further, the partial structure of phthalic acid ester may be a part of the polymer or may be regularly subjected to pendant, and further may be introduced into a part of the molecular structure of additives such as antioxidants, acid scavengers, or UV absorbers. Of the above compounds, preferred are phosphoric acid aryl ester and arylenebis(diaryl phosphate) and specifically preferred are triphenyl phosphate and phenylenebis(diphenyl phosphate).

Specifically listed as polymer plasticizers are aliphatic hydrocarbon based polymers; alicyclic hydrocarbon based polymers; acryl based polymers such as ethyl polyacrylate or methyl polymethacrylates; vinyl based polymers such as polyvinyl isobutyl ether or polyN-vinylpyrrolidone; styrene based polymers such as polystyrene or poly-4-hydroxystyrene; polyester such as polybutylene succinate, polyethylene terephthalate, or polyethylene naphthalate; polyether such as polyethylene oxide or polypropylene oxide; polyamide; polyurethane, and polyurea. The number average molecular weight of the above is preferably about 1,000-500,000, but is most preferably 5,000-200,000. When it is at most 1,000, volatility problems occur, while when it exceeds 500,000, plasticizing capability decreases to result in adverse mechanical properties. These polymer plasticizers may be homopolymers composed of a single kind of repeated units or copolymers having a plurality of repeated structures. Further, at least two types of the above polymers may be simultaneously employed.

The added amount of other plasticizers is commonly 0.1-50 parts by weight with respect to 100 parts by weight of the cellulose ester, is preferably 1-30 parts by weight, but is more preferably 3-15 parts by weight.

### (Additives)

In the optical cellulose ester film of the present invention, other than the above plasticizers, it is possible to incorporate additives which exhibit the same function as the above plasticizers. For example, low-molecular organic compounds capable of plasticizing a cellulose ester film results in the same effects as plasticizers. These components are not added directly to plasticize films compared to the plasticizers, but exhibit the same function as the above plasticizers, depending on the added amount.

Further, in the present invention, in order to regulate the tint of film, blue dyes, for example, may be employed as an additive. Preferred dyes include anthraquinone based dyes, which may have any of the substituents from position 1 to position 8 of anthraquinone. Preferred substituents include an anilino group which may be substituted, a hydroxyl group, an amino group, a nitro group or a hydrogen atom. The added amount of these dyes into film is commonly 1-1,000 μg/m² to retain transparency of the film, but is preferably 10-100 μg/m².

In the optical cellulose ester film of the present invention, further added may be at least one of the stabilizers selected from phenol based stabilizers, hindered amine based stabilizers, phosphor based stabilizers, sulfur based stabilizers, or benzofuranone based stabilizers.

As preferred phenol based stabilizers employed may be those known in the art. Examples thereof include acrylate based compounds, described in JP-A Nos. 63-179953 and 1-168643, such as 2-t-butyl-6-(3-t-butyl-2-hydroxy-5-methylbenzyl)²4-methylphenyl acrylate or 2,4-di-t-amyl-6-(1-(3,5-di-t-amyl-2-hydroxyphenyl)ethylphenyl acrylate; alkyl-substituted phenol based compounds such as octadecyl-3-(3,5-di-t-butyl-4-hydroxyphenyl)propionate, 2,2′-methylene-bis(4-methyl-6-t-butylpnenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenyl propionate)methane, namely pentaerythrimethyl-tetrakis(3-(3,5-di-butyl-4-hydroxyphenyl propionate)), triethylene glycol-bis(3-t-butyl-4-hydroxy-5-methylphenyl)propionate); and triazine group containing phenol based compounds such as 6-(4-hydroxy-3,5-di-t-butylanilino)-2,4-bisoctylthio-1,3,5-triazine, 4-bizoctylthio-1,3,5-triazine, or 2-octylthio-4,6-bis-(3,5-di-butyl-4-oxyanilino)-1,3,5-triazine.

Further, listed as preferable hindered amine based stabilizers are bis(2,2,6,6-tetramethyl-4-piperidyl)sebacate, bis(2,2,6,6-tetramethyl-4-piperydyl)succinate, bis(1,2,2,6,6-pentamethyl-4-piperidyl)sebacate, bis(N-octoxy-2,2,6,6-tetramethyl-4-piperydyl)sebacate, bis(N-benzyloxy-2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)-2-(3,5-di-t-butyl-4-hydroxybenzyl)-2-butyl malonate, bis(1-acroyl-2,2,6,6-tetramthyl-4-piperidyl)2,2-bis(3,5-di-t-butyl-4-hydroxybenzyl)-2-butyl malonate, bis(1,2,2,6,6-pentabutyl-4-piperidyl)decanedioate, 2,2,6,6-tetremethyl-4-piperidyl methacrylate, 4-[3-(3,5-di-t-butyl-4-hydroxyphenylpropionyloxy)-1-[2-(3-(3,5-di-t-butyl-4-hydroxyphenyl)propionyloxy)ethyl]-2,2,6,6-tetramethylpiperidine, 2-methyl-2-(2,2,6,6-tetramethyl-4-piperidyl)amino-N-(2,2,6,6-tetramethyl-4-piperidyl)propionamide, tetrakis(2,2,6,6-tetramethyl-4-piperidyl)1,2,3,4-butane tetracarboxylate, and tetrakis(1,2,2,6,6)-pentamethyl-4-poeridyl]1,2,3,4-butane carboxylate.

Further, preferable phosphorous based stabilizers are not particularly limited as long as they are commonly employed in the ordinary resin industry, and examples thereof include monophosphite based compounds such as triphenyl phosphite, diphenylisodecyl phosphite, phenyldiisodecyl phosphite, tris(nonylphenyl)phosphite, tris(dinonylphenyl)phosphite, tris(2,4-di-t-butylphenyl)phosphite, 10-(3,5-di-butyl-4-hydroxybenzyl)-9,10-dihydro-9-oxa-10-phosphaphenenatholene-10-oxide, or 6-[3-t-butyl-4-hydroxy-5-methylphenyl]propoxy]-2,4,8,10-tetra-t-butylbenz[d,f][1.3.2]dioxaphosphepine; and diphosphite based compounds such as 4,4′-butylidene-bis(3-methyl-6-t-butylphenyl-di-tridecyl phosphite), 4,4′-isopropylidene-bis(phenyl-di-alkyl(C12-C15)phosphite). Further listed are phosphonate compounds such as tetrakis(2,4-di-t-butyl-phenyl)-4,4′-biphenylene diphosphonite, or tetrakis(2,4-di-t-butyl-5-methylphenyl)-4,4′-biphenylene phosphorite.

Examples of more preferable sulfur based stabilizers include lauryl 3,3-thiodipropionate, dimyristyl 3,3′-thiodipropionate, distearyl 3,3-thiodipropionate, laurylstearyl 3,3-thiodipropinate, pentaerythritol-tetrakis-(β-lauryl-thio-propionate), and 3,9-bis(2-dodecylthioethyl)-2,4,8,10-tetraoxaspyro[5,5]undecane.

Preferable benzofuranone based stabilizers include 3-[4-(2-acetoxyrthoxy)phenyl]-5,7-di-t-butylbenzofuran-2-one, 5,7-di-t-butyl-3-[4-(2-stearoylocyethoxy)phenyl]benzofuran-2-one, 3,3′-bis[5,7-di-t-butyl-3-(4-[2-hydroxyethoxy]phenyl)benzofuran-2-one], 5,7-di-t-butyl-3-(4-methoxyphenyl)benzofuran-2-one, 5,7-di-t-butyl-3-phenylbenzofuran-2-one, 5,7-di-t-butyl-4-methyl-3-phenylbenzofuran-2-one, 3-(acetoxy-3,5-dimethylphenyl)-5,7-di-t-butylbenzofuran-2-one, 3-(3,5-dimethyl-4-pivaloyloxyphenyl)-5,7-di-t-butylbenzofuran-2-one, 3-(3,4-dimethylphenyl)-5,7-di-t-butylbenzofuran-2-one, and 3-(2,3-dimethylphenyl)-5,7-di-butyl-benzofuran-2-one.

Examples of these compounds are listed below, however the present invention is not limited thereto.
IRGANOX 1010: produced by Ciba Specialty Chemicals Corp.
TINUVIN 770: produced by Ciba Specialty Chemicals Corp.
TINUVIN 144: produced by Ciba Specialty Chemicals Corp.
ADK STABLA LA-52: produced by ADEKA Corp.
SUMILIZER GP: produced by Sumitomo Chemical Co., Ltd.
PEP-24G: produced by ADEKA Corp.
SUMILIZER TP-D: produced by Sumitomo Chemical Co., Ltd.
PEP-36: produced by ADEKA Corp.
IRGAFOSP-EPQ: produced by Ciba Specialty Chemicals Corp.
GSY-P101: produced by Sakai Chemical Industry Co., Ltd.
SUMILIZER GM: produced by Sumitomo Chemical Co., Ltd.
SUMILIZER GS: produced by Sumitomo Chemical Co., Ltd.

It is possible to employ at least one type of these stabilizers in combination for the above phosphorous acid esters. The blended amount is selected in the range which does not adversely affects the purposes of the present invention. The above blended amount is commonly 0.001-10.0 parts by weight with respect to 100 parts by weight of the cellulose ester, is preferably 0.01-5.0 parts by weight, but is more preferably 0.1-3.0 parts by weight.

When a cellulose ester film is manufactured via heat melting, the moisture content in the cellulose ester film is preferably at most 3.0% by weight. The cellulose ester film, at a moisture content of at most 3.0 by weight, preferably incorporates at least one of the additives prior to heat melting.

Incorporation of additives, as described in the present invention, includes a state in which additives are not only incorporated in the interior of the ester but are also simultaneously incorporated in the interior and on the surface.

Methods to incorporate the additives in the interior include any in which after dissolving cellulose ester in solvents, additives are dissolved in or dispersed into the resulting solution to form minute particles, followed by removal of employed solvents. It is possible to employ conventional methods to remove above solvents, and examples thereof include a submerged drying method, an ambient air drying method, a solvent co-precipitation method, a freeze-dry method, and a solution flow casting method. It is possible to modify a mixture of cellulose ester and additives after solvent removal to become powders, granules, pellets and film. As mentioned above, incorporation of additives is realized by dissolving cellulose ester solids. However, simultaneous incorporation may be realized during deposition and solidification in the cellulose ester synthesis process.

In the submerged drying method, for example, an aqueous solution of surface active agents such as sodium lauryl phosphate is added to a solution in which cellulose ester and additives have been dissolved, whereby emulsification dispersion is achieved. Subsequently, solvents are removed via normal or reduced pressure distillation, whereby it is possible to prepare a cellulase ester dispersion incorporating additives, Further, in order to remove the surface active agents, it is preferable to employ centrifugal separation and decantation. As an emulsification method, it is possible to employ various methods, and it is preferable to employ homogenizers via ultrasonic waves, high-speed rotation shearing, and high pressure.

During emulsification dispersion employing ultrasonic waves, it is possible to employ one of two systems, namely a batch system or a continuous system. The batch system is suitable to prepare a relatively small amount, while the continuous system is suitable for larger amounts. In the continuous system, it is possible to employ an apparatus such as UH-600SR (produced by SMT Co., Ltd.). In such a continuous system, it is possible to obtain ultrasonic wave exposure time via dispersion chamber volume/flow rate×circulation frequency. When a plurality of ultrasonic wave exposure apparatuses is employed, the overall exposure time is obtained from the total of each exposure time. In practice, the exposure time of ultrasonic waves is less than 10,000 seconds. When the necessary exposure time is at least 10,000 seconds, load on the process increases, and in such a case, it is necessary to decrease the emulsification dispersion time via re-selection of emulsifiers. As a result, an exposure time of at least 10,000 seconds becomes unnecessary. The exposure time is more preferably 10-2,000 seconds.

It is possible to employ, as an emulsification dispersion apparatus due to high speed rotation shearing, a disper mixer, a homomixer, or an ultra mixer. It is possible to appropriately employ any of these devices depending on the solution viscosity during emulsification dispersion.

During emulsification dispersion under high pressures, it is possible to employ LAB2000 (produced by SMT Co., Ltd.). Its emulsification dispersion capability depends on the pressure applied to samples. The pressure is preferably in the range of 10⁴-5×10⁵ kPa.

It is possible to employ, as a surface active agent, anionic surface active agents, cationic surface active agents, amphoteric surface active agents, or polymer dispersing agents, and it is further possible to select any of these depending on solvents and particle diameter of targeted emulsions.

The ambient air drying method refers to drying in which, by employing a spray dryer such as GS310 (Yamato Scientific Co., Ltd.), a solution in which cellulose ester and additives are dissolved is sprayed and dried.

In the solvent coprecipitation method, a solution, in which cellulose ester and additives are dissolved, is added to poor solvents with respect to the cellulose ester and additives to result in precipitation. It is possible to mix poor solvents in an arbitrary ratio, with the above solvents which dissolve cellulose ester. The poor solvent may be composed of mixed solvents. Further, it is allowable that poor solvents are added to a solution of cellulose ester and additives.

A precipitated mixture of the cellulose and additives may be filtered, dried and separated.

In the mixture of the cellulose ester and additives, the particle diameter of the additives in the mixture is commonly at most 1 μm, is preferably at most 500 nm, but is more preferably at most 200 nm. It is preferable that the diameter of additive particles is as small as possible since the distribution of mechanical and optical characteristics of molten products becomes uniform.

It is preferable that the above mixture of cellulose ester and additives, and additives which are added during heat melting, are dried prior to heat melting or during heat melting. Being dried, as described herein, refers to the removal of any of the moisture absorbed by any of the molten materials, water and solvents employed during preparation of the mixture of cellulose ester and additives, and solvents mixed during synthesis of additives.

It is possible to employ, as the above removal method, conventional drying methods such as a heating method, a reduced pressure method, or a heating-reduced pressure method, and it may be carried out in atmosphere, or in an ambience of nitrogen selected as an inert gas. When drying is carried out employing any of these conventional drying methods, in view of film quality, it is preferable that drying is carried out in the temperature range in which no materials result in decomposition.

For example, residual moisture or solvents, after removal in the above drying process, is regulated to be at most 10% by weight with respect to the entire weight of constituting materials, preferably at most 5% by weight, more preferably at most 1% by weight, but further more preferably at most 0.1% by weight. Drying temperature in such a case is preferably at least 100° C. and at most the Tg of the drying materials. In view of avoiding fusion among materials, the drying temperature is preferably 100° C.−(Tg−5)° C., but is more preferably 110° C.−(Tg−20)° C. Drying time is preferably 0.5-24 hours, is more preferably 1-18 hours, but is further more preferably 5-12 hours. When the drying temperature is lower than the lower limit, degree of drying is lowered or the drying time may be excessively extended. Further, when dried materials exhibit Tg, drying temperature higher than the Tg results in fusion whereby handling occasionally becomes difficult.

The drying process may be divided into at least two stages. For example, molten film production may be conducted via the storage of materials via a preliminary drying process and a drying process which is carried between just and one week before the above production.

Further, it is preferable that, as a matting agent, minute partials are added to the optical cellulose ester film of the present invention. Minute particles, which are employed in the present invention, include inorganic compounds such as silicon dioxide, titanium dioxide, aluminum oxide, zirconium oxide, calcium carbonate, talc, clay, sintered calcium silicate, hydrated calcium silicate, aluminum silicate, magnesium silicate, and calcium phosphate.

The average diameter of the primary particles of minute silicon dioxide is preferably 5-16 nm, but is more preferably 5-12 nm. It is preferable that the average diameter of the primary particles is less since any resulting haze is lowered. Further, apparent specific gravity is preferably 90-200 g/L, but is more preferably 100-200 g/L. An increase in the apparent specific gravity is preferable since it becomes possible to prepare a higher concentration dispersion to minimize haze and coagulates.

The added amount of matting agents is preferably 0.01-1.0 g per m², is more preferably 0.03-0.3 g, but is most preferably 0.10-0.18 g.

Examples of minute silicon dioxide particles include AEROSIL R972, R972V, R974, R812, 200, 200V, 300, R202, OX50, and TT600, produced by Nippon Aerosil Co., Ltd. and of these, AEROSIL 220V and R972 are particularly preferred due to the following; they are composed of minute silicon dioxide particles at an average particle diameter of the primary particle of at most 20 nm and at an apparent specific gravity of at least 70 g/L, and while maintaining the turbidity of the cellulose ester film at a low value, exhibit a large effect to lower the friction coefficient.

Further, minute zirconium oxide particles are commercially available, for example, under trade names AEROSIL R976 and R811 (both produced by Nippon Aerosil Co., Ltd.). Further, listed as an example of polymers may be silicone resins, fluororesins, and acryl resins. Preferred as silicone resins are those particularly having a three-dimensional net structure, and examples thereof are commercially available under the trade names TOSPAL 103, 105, 108, 120, 145, 3120, and 240 (produced by Toshiba Silicone Co, Ltd.)

With regard to these minute particles, the average particle diameter of formed secondary particles is preferably 0.01-1.0 μm, is more preferably 0.1-0.8 μm, but is most preferably 0.2-0.5 μm. These minute particles exist on the film surface in the faint of aggregates of the primary particles to create a 0.01-1.0 μm roughness. The content of these minute particles is preferably 0.005-0.3% by weight, is more preferably 0.05-0.2% by weight, but is most preferably 0.1-0.2% by weight.

In the optical cellulose ester film of the present invention, in order to enhance quality of a liquid crystal display, a polarizing plate may undergo processes in which an orientation film is formed so that a liquid crystal layer is provided, and optical compensation capability is provided by combining the cellulose ester film and retardation due to the liquid crystal layer. It is possible to employ, as a compound which is added to regulate retardation, aromatic compounds having at least two aromatic rings, described in European Patent No. 911,656A2. Alternately, at least two types of aromatic compounds may be simultaneously employed. The aromatic ring of the above aromatic compounds incorporates, in addition to an aromatic hydrocarbon ring, an aromatic heterocyclic ring. It is particularly preferable that it be an aromatic heterocyclic ring, and the above aromatic heterocyclic rings are commonly unsaturated heterocyclic rings. Of these, a 1,3,5-triazine ring is particularly preferred.

With regard to dimensional stability of the optical cellulose ester film of the present invention, the dimensional variation is preferably less than ±1.0% at 80° C. and 90% relative humidity with respect to the dimension of film which has been allowed to stand at 23° C. and 55% relative humidify for 24 hours, is more preferably less than 0.5%, but is most preferably less than 0.1%.

The optical cellulose ester film of the present invention is employed as a protective film for polarizing plates. Accordingly, when cellulose ester film itself results in variation exceeding the above range, the absolute value of retardation and orientation angle as the polarizing plate deviate from the original settings, whereby occasionally, lowering of the enhanced capability of the stated quality or degradation of stated quality results.

In view of retarding or minimizing generation of volatile components due to modification or decomposition of at least one of the above cellulose esters, plasticizers, or antioxidants, or in addition, UV absorbers, matting agents, or retardation controlling agents which are incorporated as desired, presence of additives in the film constituting materials result in excellent targeted effects. Further, it is desirable that additives themselves do not generate volatile components in the melting temperature range of the film constituting materials.

When film constituting materials are melted, the content of volatile components is commonly at most 1% by weight, is preferably at most 0.5% by weight, is more preferably at most 0.2% by weight, but is most preferably at most 0.1% by weight. In the present invention, a decrease in weight via heating from 30-350° C. is determined via a differential thermogravimeter (TG/DTA200, produced by Seiko Instruments Inc.), and the resulting weight is designated as the content of volatile components.

It is possible to control the refractive index of the optical cellulose ester film via a stretching operation. It is possible to control the refractive index within a preferred range by stretching cellulose ester by a factor of 1.0-2.0 in one direction and by stretching the same by a factor of 1.01-2.5 perpendicular to the above direction.

For example, it is possible to sequentially or simultaneously achieve stretching in the longitudinal direction of film, as well as in the orthogonal direction within the film plane, namely in the lateral direction. In this case, when the stretching factor is excessively small with respect to at least one direction, it is not possible to realized sufficient retardation, while when it is excessively large, it becomes difficult to achieve stretching, whereby breakage occasionally results.

In the case of stretching in the casting direction via melting, when contraction in the lateral direction is excessively large, the refractive index in the film thickness direction becomes excessive. In this case, it is possible to improve by retarding width contraction of, film or by stretching film in the lateral direction. When stretched in the lateral direction, the resulting refractive index occasionally exhibits non-uniform lateral distribution. The above distribution is occasionally observed when a tenter method is employed. This phenomenon occurs in such a manner that contractive force is generated in the central portion of the film via stretching in the lateral direction, while both edges are fixed. This is considered as a phenomenon, which is the so-called bowing phenomenon. Even in this case, by stretching the film in the casting direction, it is possible to retard the bowing phenomena, whereby it is possible to improve so that the distribution of the lateral retraction is minimized.

Further, by carrying out stretching in the biaxial directions which are perpendicular to each other, it is possible to reduce the thickness fluctuation of the resulting film. When thickness fluctuation of cellulose ester film is excessively large, the resulting retardation is not uniform, and when employed in liquid crystal displays, mottling such as coloration occasionally results in problems.

Thickness fluctuation of cellulose ester film supports is preferably regulated within a range of ±3%, but more preferably within ±1%. In the purposes as described above, a method is effective in which stretching is carried out in the biaxial directions which are perpendicular to each other. The final stretching factors in the biaxial directions which are perpendicular to each other is preferably in the range of 1.0-2.0 in the casting direction and 1.01-2.5 in the lateral direction, but is more preferably in the range of 1.01-1.5 in the casting direction and 1.05-2.0 in the lateral direction.

When cellulose ester is employed which results in double refraction under stress, by carrying out stretching in the lateral direction, it is possible to provide a delayed phase axis of the cellulose ester film in the lateral direction. In this case, in the present invention, to enhance display quality, it is preferable that the delayed phase axis is located in the lateral direction and it is necessary to satisfy the relationship of (stretching factor in the lateral direction) a (stretching factor in the casting direction).

Methods to stretch a web are not particularly limited, and examples thereof include a method in which a plurality of rollers is subjected in difference in the peripheral speed, whereby stretching is carried out in the longitudinal direction, utilizing the difference in the peripheral speed of rollers, a method in which both edges of a web are fixed via clips or pins and stretching in the longitudinal direction is carried out by spreading the distance between the clips or pins in the moving direction, a method in which the above distance is spread in the lateral direction in the same manner as above, whereby stretching in the lateral direction is carried out, or a method in which the longitudinal and lateral distance are simultaneously spread, whereby stretching in the longitudinal and lateral directions is carried out. Naturally, these methods may be employed simultaneously. Further, in the case of the so-called tenter method, it is preferable to drive clip portions employing a linear drive, whereby it is possible to carry out smooth stretching, to result in decreased danger such as breakage.

It is preferable that such width retention and stretching in the lateral direction during any film production process are carried out employing a tenter, and a pin tenter or a clip tenter may be employed.

when the optical cellulose ester film of the present invention is employed as a polarizing plate protective film, the thickness of the above protective film is preferably 10-500 μm, is more preferably 20-35 μm, but is preferably at most 150 μm, but is further preferably at most 120 μm, but most preferably 25-90 μm. When the cellulose ester film is more than the upper limit, the thickness of the resulting polarizing plates is excessive, whereby liquid crystal displays employed in laptop computers or mobile type electronic devices are not suitable for a targeted thin device of light weight. On the other hand, it is not preferable that the thickness is less than the lower limit, since it becomes difficult to generate retardation and moisture permeability of the film is not sufficient, whereby capability of protecting a polarizer from moisture is degraded.

A delayed phase axis or an advanced phase axis of the optical cellulose ester film of the present invention exists within the film plane, and θ1 is preferably −1° to +1°, but is more preferably −0.5° to +0.5° C., where θ1 represents the angle with respect to the film producing direction. It is possible to define above θ1 as an orientation angle, and to determine θ1 by employing an automatic birefringence analyzer, KOBRA-21ADH (produced by Oji Scientific Instruments Co., Ltd.).

When θ1 each satisfies the above relationship, it is possible to obtain high luminance in displayed images, to contribute to retardation or prevention of light leakage, and also to contribute to realize faithful color reproduction in color liquid crystal display devices.

The optical cellulose ester film of the present invention may be mixed with appropriately selected polymer materials and oligomers. Of the above polymer materials and oligomers, those which exhibit excellent compatibility with cellulose ester are preferred. Further, when modified to film, the resulting transmittance is preferably at least 80, is more preferably 90%, but is further more preferably at least 92%. The purpose to blend at least one type of the polymer materials and oligomers, except for cellulose ester, includes a meaning in which viscosity control during heat melting and physical properties after film treatment are improved. In such a case, it may be incorporated as another of additives described above.

After thermal or vacuum drying a mixture of cellulose esters according to the present invention and additives, the dried mixture is melt-extruded, extruded into film from a T type die, and the extruded film is brought into close contact with a cooling drum employing a method such as an electrostatic application method, cooled and solidified, whereby a non-stretched film is prepared. It is preferable that the temperature of the cooling drum is maintained between 90-150° C.

Molten extrusion may be carried out employing a uniaxial extruder or a biaxial extruder, or a uniaxial extruder, located downstream, which is linked to a biaxial extruder. However, in view of mechanical and optical characteristics, it is preferable to employ the uniaxial extruder. Further, it is preferable that raw martial feeding, and melting processes such as a raw martial tank, a material charging section, and the interior of the extruder are subjected to an replacement to inert gases such as nitrogen gas or reduced pressure.

The temperature during the above molten extrusion is commonly in the range of 150-300° C., is preferably in the range of 180-270° C., but is more preferably in the range of 200-250° C.

When a polarizing plate is prepared by employing the optical cellulose ester film of the present invention as a polarizing plate protective film, it is particularly preferable that the above cellulose ester film is stretched in the lateral direction or in the casting direction.

It is preferable that a non-stretched film prepared by peeling from the above cooling drum is heated to the range of glass transition temperature (Tg) to (Tg+100)° C. via a plurality of groups of rollers and/or a heating apparatus such as an infrared ray heater and is subjected to a single stage or a multiple-stage longitudinal stretching. Subsequently, the cellulose ester film which is stretched in the longitudinal direction, as described above, is also stretched in the lateral direction in the temperature range of Tg to (Tg−20)° C., followed by thermal fixing.

In the case of lateral stretching, it is preferable that such lateral stretching is carried out in the range of a temperature difference of 1-50° C. in stretched region which is divided to at least two while gradually increasing the temperature, since it is thereby possible to realize uniform distribution of physical properties in the lateral direction. Further, it is preferable that after lateral stretching, the resulting film is maintained in the range of at most final lateral stretching temperature—at least (Tg−40)° C. for 0.01-5 minutes, since it is thereby possible to realize more uniform distribution of physical properties in the lateral direction.

Thermal fixing is commonly carried out in the temperature range of at least the final lateral stretching temperature and at most (Tg−20)° C. for 0.5-300 seconds. During the above operation, it is preferable that thermal fixing is carried out in the region which is divided into at least two in the range of temperature difference of 1-100° C., while gradually increasing the temperature.

The thermally fixed film is commonly cooled to at most Tg, and after cutting away the clip-held portions of both film edges, it is wound up. During this operation, it is preferable to carry out a 0.1-10% relaxation treatment in the lateral direction and/or the longitudinal direction in the temperature range of at most the final thermal fixing temperature to at least Tg. Further, it is preferable that cooling is carried out from the final thermal fixing temperature to Tg at a cooling rate of at most 100° C. per second. The means for cooling and for the relaxation treatment are not particularly limited and conventional means are applicable. However, in view of enhancement of film dimensional stability, it is specifically preferable that these treatments are carried out by sequentially cooling in a plurality of temperature regions. The cooling rate is the value obtained by (T1−Tg)/t, where T1 represents the final thermal fixing temperature and t represents the time for which the film temperature reaches Tg from the final thermal fixing temperature.

Optimal thermal fixing conditions, as well as cooling and relaxation conditions depend on cellulose ester which constitutes the film. Therefore, these conditions may be determined in an appropriately manner, whereby physical properties of the resulting biaxially stretched film are determined and preferred characteristics are realized.

During production of the optical cellulose ester film of the present invention, prior to and/or after stretching, coated may be functional layers such as an antistatic layer, a hard coat layer, an antireflection layer, a slippery layer, an adhesion layer, an antiglare layer, a barrier layer, or an optical compensating layer. Specifically, it is preferable to provide at least one layer from the antistatic layer, the hard coat layer, the antireflection layer, the adhesion layer, the antiglare layer, and the optical compensation layer. In such a case, if desired, applied may be various surface treatments such as a corona discharge treatment, a plasma treatment, or a chemical treatment.

Further, in the optical cellulose ester film of the present invention, layers which differ in the type of cellulose ester, or the type of additives and contents may be co-extruded, whereby a cellulose ester film of a multilayer structure may be prepared.

For example, it is possible to prepare a cellulose ester film structured of a skin layer/core layer/skin layer. For example, the amount of minute particles such as matting agents is relatively large in the skin layer, or they may be incorporated only in the skin layer. Further, in the skin layer, a melt-extrusion layer may be formed employing diacetyl cellulose which is easily saponified. It is possible to realize melt-extrusion of diacetyl cellulose employing conventional methods. It is further possible to incorporate low-volatile plasticizers and/or UV absorbers in the skin layer, as well as to add plasticizers exhibiting excellent plasticizing properties and UV absorbers exhibiting excellent UV absorption to the core layer. The glass transition temperature of the skin layer may be different from that of the core layer, and the glass transition temperature of the core layer may be lower than that of the skin layer. Further, the viscosity of melt incorporating cellulose ester during melt extrusion may differ between the skin layer and the core layer, and either viscosity of the skin layer>viscosity of the core layer or viscosity of the core layer≧viscosity of the skin layer may be acceptable. However, when the viscosity of a thin layer (commonly a skin layer) is higher, it is possible to prepare a multilayer exhibiting uniform film thickness.

### (Polarizing Plate and Liquid Crystal Display Device)

When the optical cellulose ester film of the present invention is employed as a polarizing plate protective film to prepare a polarizing plate, it is preferable that at least one surface is the polarizing plate of the present invention, but it is more preferable that both sides are the polarizing plates of the present invention.

As a conventional polarizing plate protective film, employed are cellulose ester films such as KONICA MINOLTA TAC KC8UX, KC4UX, KC5UX, KC8UY, KC4UY, KC8UCR-3, KC8UCR-4, KC12UR, KC8UXW-H, KC8UYW-HA, or KC8UX-RHA (produced by Konica Minolta Opto, Inc.).

Preparation methods of the polarizing plate of the present invention are not particularly limited, and it is possible to prepare it by common methods. Such a prepared polarizing plate protective film is subjected to an alkali treatment, and is adhered, employing an aqueous completely saponified polyvinyl alcohol solution, to both sides of the polarizer which has been prepared by immerse-stretching a polyvinyl alcohol film in an iodine solution. This method is preferable since it is possible to allow the polarizing plate protective film of the present invention to adhere to at least one side.

Further, instead of the above alkali treatment, a polarizing plate may be subjected to the treatment to facilitate adhesion, described in JP-A Nos. 6-94915 and 6-118232.

Further, a polarizing plate is composed of a polarizer and protective films which protect both sides thereof. Further, it is possible to compose a polarizing plate by allowing a protective film to adhere to one side of a polarizing plate and a separate film to adhere to the opposite side. The protective film and the separate film are employed to protect a polarizing plate during shipping and transportation thereof. In such a case, the protective film is adhered to protect the surface of a polarizing plate and is employed on the surface opposite to the surface to which a polarizing plate is adhered to a liquid crystal cell. Further, the separate film is employed to cover an adhesion layer.

In a liquid crystal display device, a substrate incorporating liquid crystals is commonly arranged between two polarizing plates. The polarizer protective film to which the cellulose ester film of the present invention is applied exhibits excellent dimensional stability. Consequently, when arranged in any portion, excellent display properties are realized. It is preferable to employ, as a polarizer protective film of the uppermost surface on the display side of a liquid crystal display device, a polarizer protective film provided with a clear hard coat layer, an antiglare layer, and an antireflective layer. Further, in the case of a polarizer protective film provided with an optical compensating layer and a polarizer protective film provided with optical compensation capability due to stretching operation, excellent display properties are realized via arrangement in the position in contact with the liquid cell. Specifically, it is possible to more effectively exhibit targeted effects of the present invention via application to a multi-domain type liquid crystal display device, or preferably to a multi-domain type liquid crystal display device via a birefringence mode.

Realizing a multi-domain, as described herein, refers to a system in which a liquid cell composed of a single pixel is divided into plural portions which is suitable for improvement of viewing angle dependence and enhancement of symmetry of image display, and various systems are reported (Okita and Uchiyaman, Ekisho (Liquid Crystal), 6(3), 303 (2002). The above liquid crystal display cell is described in Yamada and Yamahara, Ekisho (Liquid Crystal), 7(2), 184 (2003), however the present invention is not limited thereto.

Preferred display quality of a display cell is that left and right is symmetrical when viewed. Consequently, when the display cell is a liquid crystal cell, it is possible to make it a multi-domain while, symmetry of the viewing side is substantially placed at a higher priority. It is possible employ conventional methods to prepare a multi-domain. While considering properties of the conventional liquid crystal mode, by employing a 2-division method and preferably a 4-division method, it is possible to make decision at that time.

It is possible to effectively employ the polarizing plate of the present invention in an MVA (Multi-domain Vertical Alignment) mode represented by a vertical alignment mode, particularly a 4-division MVA mode, a conventional PVA (Patterned Vertical Alignment) mode which is subjected to multi-domain by electrode arrangement, a CPA (Continuous Pinwheel Alignment) mode which integrates electrode arrangement and chiral ability. Further, with regard to suitability to an OCB (Optical Compenbated Bend) mode, an optically biaxial film is proposed (T. Miyashita and T. Uchida, J. SID, 3(1), 29 (1995), and by employing the polarizing plate of the present invention, it is possible to realize targeted effects of the present invention with regard to display quality. When it is possible to realize targeted effects of the present invention by employing the polarizing plate of the present invention, liquid crystal modes and arrangement of polarizing plates are not particularly limited.

The above liquid crystal display device exhibits high performance as a device to display full-color and moving images. Consequently, the display quality of the liquid crystal display devices, especially large-sized ones, enables faithful moving image display while resulting in least eye fatigue.

### Synthesis Examples

Synthetic methods of the compounds of the present invention will now be specifically described, however the present invention is not limited thereto.

### Synthesis Example 1

### Synthesis of Exemplified Compound 2

Suspended in 10 ml of toluene was 2 g of Compound A, followed by the addition of 0.1 ml of DMF and 1.14 g of thionyl. The resulting mixture was heated to 60° C. and stirred for 30 minutes. Along with progress of the reaction, dissolution was initiated, and after completion of the reaction, a homogeneous solution was obtained. Subsequently, solvents in the reaction mixture were removed under reduced pressure. By adding 80 ml of acetonitrile to the residue, a suspension was prepared. In another vessel, 0.34 g of diethylene glycol and 0.76 g of pyridine were dissolved in acetonitrile, and while stirring, the resulting solution was heated to 75° C. The above acetonitrile suspension was quickly added to the above solution and the resulting mixture was stirred for two hours while heated at 75° C. After completion of the reaction, the reaction mixture was cooled and acetonitrile was removed under reduced pressure, followed by extraction via the addition of ethyl acetate and water. The resulting organic layer was removed under reduced pressure. The residue was purified via silica gel column chromatography and further, recrystallization was conducted employing ethyl acetate, whereby 0.4 g (at a yield of 180) of Exemplified Compound 2 was prepared. Its structure was confirmed via NMR and mass spectra.

1H-NMR (d-DMSO): δ1.28 (s, 18H); 3.92 (m, 4H); 4.51 (m, 4HH); 7.09 (d, J=8.8 Hz, 2H); 7.49 (dd, J=2.4 Hz, 8.5 Hz, 2H); 7.71 (d, J=2.4 Hz, 2H); 7.93 (d, J=8.8 Hz, 2H); 7.99 (d, J=8.8 Hz, 2H); 8.60 (s, 2H); 10.2 (s, 2H)

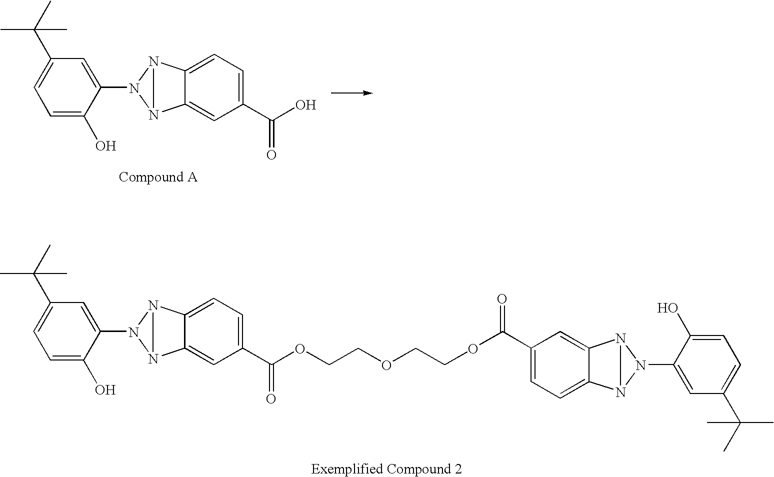

### Synthesis Example 2

### Synthesis of Exemplified Compound 3

In 10 ml of toluene, suspended was 2 g of Compound A, followed by the addition of 0.1 ml of DMF and 1.14 g of thionyl chloride. The resulting mixture was heated to 60° C. and stirred over 30 minutes. Along with progress of the reaction, dissolution was initiated, and after completion of the reaction, a homogeneous solution was obtained. Subsequently, solvents in the reaction mixture were removed under reduced pressure. By adding 80 ml of acetonitrile to the residue, a suspension was prepared. In another vessel, 0.33 g of 2,2-dimethylpropanediol and 0.33 g of pyridine were dissolved in 0.76 g acetonitrile, and while stirring, the resulting solution was heated to 75° C. The above acetonitrile suspension was quickly added into the above solution and the resulting mixture was stirred for two hours while maintained at 75° C. After completion of the reaction, the reaction mixture was cooled and acetonitrile was removed under reduced pressure followed by extraction via the addition of ethyl acetate and water. The resulting organic layer was removed under reduced pressure. The residue was purified via silica gel column chromatography, and further, recrystallization was conducted employing ethyl acetate, whereby 0.4 g (at a yield of 18s) of Exemplified Compound 3 was prepared. Its structure was confirmed via NMR and mass spectra.

1H-NMR (d-DMSO): 00.97 (s, 6H); 1.31 (s, 18H); 4.34 (s, 4H): 7.12 (d, d=8.8 Hz, 2H); 7.51 (dd, 3=2.4 Hz, 8.8 Hz, 2H); 7.74 (d, J=2.4 Hz, 2H); 8.04 (dd, J=1.4 Hz, 9.0 Hz, 2H); 8.18 (d, J=9.0 Hz, 4H); 8.71 (s, 211); 10.3 (s, 2H)

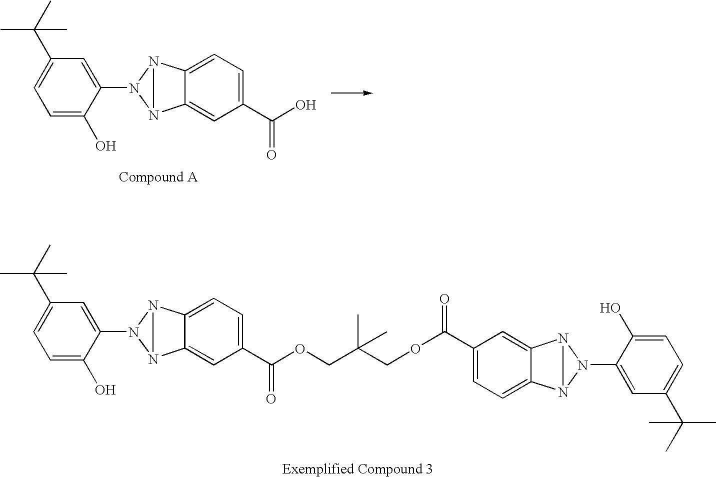

It is possible to synthesize other exemplified compounds in the same manner as above.

### EXAMPLES

Embodiments of the present invention will now be specifically described with reference to examples, however the present invention is not limited thereto. “Parts” described below represent “parts by weight”.

### Example 1

### Preparation of Optical Cellulose Ester Film Sample 1-1

Cellulose ester C-1 (CAP-482-20, produced by Eastman Chemical Co.) was dried at 120° C. over two hours under normal pressure in atmosphere and was then allowed to reach equilibrium at room temperature. Comparative Compound 1 was added to the resulting cellulose ester in an amount of 1.2 parts by weight, and the resulting mixture was heat-melted at a melting temperature of 230° C., extruded from a T die, and stretched at a stretching ratio of 1.2×1.2 at 160° C., whereby 80 μm thick Optical Cellulose Ester Film Sample 1-1 was prepared.

(Preparation of Optical Cellulose Ester Film Samples 1-2 through 1-35)

Each of Optical Cellulose Ester Film Samples 1-2 through 1-35 (all at a film thickness of 80 mm) was prepared in the same manner as Optical Cellulose Ester Film Samples 1-1, except that the types of cellulose ester and the UV absorbs were changed as listed in Table 1.

TABLE 1

| | |
|---|---|
| | Comparative Compound 1 |
| 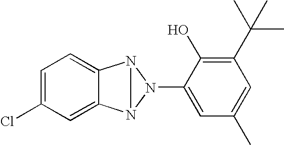 | |
| | Comparative Compound 2 |
| 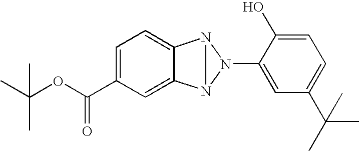 | |

| | | UV Absorber | | |
|---|---|---|---|---|
| | | | Quantity | |
| Sample | Cellulose | | (parts by | Re- |
| No. | Ester | Type | weight) | marks |
| 1-1 | C-1 | Comparative Compound 1 | 1.2 | Comp. |
| 1-2 | C-1 | Comparative Compound 2 | 1.2 | Comp. |
| 1-3 | C-2 | Comparative Compound 1 | 1.2 | Comp. |
| 1-4 | C-2 | Comparative Compound 2 | 1.2 | Comp. |
| 1-5 | C-3 | Comparative Compound 1 | 1.2 | Comp. |
| 1-6 | C-3 | Comparative Compound 2 | 1.2 | Comp. |
| 1-7 | C-4 | Comparative Compound 1 | 1.2 | Comp. |
| 1-8 | C-4 | Comparative Compound 2 | 1.2 | Comp. |
| 1-9 | C-1 | 2 | 1.2 | Inv. |
| 1-10 | C-1 | 3 | 1.2 | Inv. |
| 1-11 | C-1 | 5 | 1.2 | Inv. |
| 1-12 | C-1 | 22 | 1.2 | Inv. |
| 1-13 | C-1 | 28 | 1.2 | Inv. |
| 1-14 | C-1 | 32 | 1.2 | Inv. |
| 1-15 | C-2 | 2 | 1.2 | Inv. |
| 1-16 | C-2 | 3 | 1.2 | Inv. |
| 1-17 | C-2 | 18 | 1.2 | Inv. |
| 1-18 | C-2 | 22 | 1.2 | Inv. |
| 1-19 | C-2 | 29 | 1.2 | Inv. |
| 1-20 | C-2 | 32 | 1.2 | Inv. |
| 1-21 | C-3 | 2 | 1.2 | Inv. |
| 1-22 | C-3 | 3 | 1.2 | Inv. |
| 1-23 | C-3 | 18 | 1.2 | Inv. |
| 1-24 | C-3 | 21 | 1.2 | Inv. |
| 1-25 | C-3 | 25 | 1.2 | Inv. |
| 1-26 | C-3 | 29 | 1.2 | Inv. |
| 1-27 | C-4 | 2 | 1.2 | Inv. |
| 1-28 | C-4 | 3 | 1.2 | Inv. |
| 1-29 | C-4 | 8 | 1.2 | Inv. |
| 1-30 | C-4 | 21 | 1.2 | Inv. |
| 1-31 | C-4 | 29 | 1.2 | Inv. |
| 1-32 | C-4 | 32 | 1.2 | Inv. |
| 1-33 | C-3 | 37 | 1.2 | Inv. |
| 1-34 | C-3 | 39 | 1.2 | Inv. |
| 1-35 | C-3 | 41 | 1.2 | Inv. |

Comp.: Comparative Example,
Inv.: Present Invention
C-1: cellulose acetate propionate CAP482-20 (produced by Eastman Chemical Co.)
C-2: cellulose acetate butyrate CAB171-15 (produced by Eastman Chemical Co.)
C-3: cellulose acetate propionate (at a substitution degree of 1.9 by an acetyl group and a degree of substitution of 0.8 by a propionyl group, a molecular weight Mn of 70,000, a molecular weight Mw of 220,000, and a Mw/Mn of 3)
C-4: cellulose triacetate (at a substitution degree of 2.88 by an acetyl group, a molecular weight Mn of 148,000, a molecular weight Mw of 310,000, and a Mw/Mn of 2.1)

### (Evaluation of Optical Cellulose Ester Films)

The optical cellulose ester film samples, prepared as above, were evaluated as follows.

### (UV Absorbability)

The spectral absorption spectra of the cellulose ester films were determined employing Spectrophotometer U-3200 (produced by Hitachi, Ltd.), and transmittance at 400 nm and 380 nm was respectively noted, followed by the following rank classification. In each rank, the higher the transmittance at 400 nm, the more desirable, while the lower the transmittance at 380 nm, the more desirable.

<Transmittance at 400 nm>
A: transmittance was at least 80%
B: transmittance was at least 70% but less than 80%
C: transmittance was at least GO % but less than 70%
D: transmittance was less than 60%
<Transmittance at 380 nm>
A: transmittance was less than 5%
B: transmittance was at least 5% but less than 8%
C: transmittance was at least 8% but less than 10%
D: transmittance was at least 10%

### (Durability: Bleeding-Out)

After allowing a cellulose ester film to stand at a high temperature and humidity ambience of 80° C. and 90% relative humidity over 1,000 hours, the presence of bleeding-out (namely, crystal deposition) was visually observed and was evaluated based on the following criteria.
A: no generation of bleeding-out was noted over the entire surface
B: slight partial bleeding-out was noted on portions of the surface
C: slight bleeding-out was noted over the entire surface
D: significant bleeding out was noted over the entire surface

### (Variation Coefficient (CV) of Retardation)

The surface layer was peeled from a formed film and retardation of the resulting cellulose ester film was determined in the lateral direction at intervals of 1 cm, and the variation coefficient (CV) of the determined retardation was represented by the following formula. Determination was conducted as follows. By employing automatic birefringence analyzer KOBURA∩21ADH (produced by Oji Scientific Instruments), 3-dimensional birefringence index was determined at wavelength 590 nm at intervals of 1 cm in the lateral direction of the sample at an ambience of 23° C. and 55% relative humidity, and measured values were substituted in the following formulae and retardation values were calculated.

In-plane retardation Ro=(nx−ny)×d

Thickness direction retardation Rt=((nx+ny)/2−nz)×d

wherein d represents the thickness (nm) of film, refractive index nx represents the maximum in-plane refractive index, called the refractive index in the delayed phase axis direction, nz represents the refractive index of film in the direction perpendicular to the delayed phase axis of the in-plane of film, nz represents the refractive index of film in the thickness direction. Each of the standard deviations of the resulting retardation in the in-plane and thickness directions was obtained employing an (n−1) method. With the retardation distribution, variation coefficient (CV), described below, was obtained and designated as an index. In practical determinations, n was set in the range of 130-140.

Variation coefficient (CV)=standard deviation/average value of retardation
A: variation coefficient (CV) was less than 1.5%
B: variation coefficient (CV) was at least 1.5% but less than 5%
C: variation coefficient (CV) was at least 5a but less than 10%
D: variation coefficient (CV) was at least 10%

### (Haze)

Based on the results determined by a haze meter (Type 1001DP, produced by Nippon Denshoku Industries Co., Ltd.), haze was represented in terms of the value at a thickness of 80 μm of the sample. Evaluation was made based on the following criteria.

A; haze was less than 0.5%
E: haze was 0.5 but less than 1.0%
C: haze was 1.0 but less than 1.50
D: haze was at least 1.50

### (Lightfastness)

After cellulose ester film was subjected to alkali saponification based on the method described below, a polarizing plate was prepared. Subsequently the parallel transmittance (H0) and orthogonal transmittance (H90) of the untreated sample were determined and its polarization degree was calculated based on the following formula. Thereafter, each of the polarizing plates was subjected to 500 hours of accelerated aging employing SUN SHINE WEATHERMETER without a UV cut filter, parallel transmittance (H0′) and orthogonal transmittance (H90′) were again determined, and polarization degrees P0 and P500 were calculated based on the following formula, and the variation of the polarization degree was obtained based on the following formula.

### <Alkali Saponification>

| | | | |
|---|---|---|---|
| Saponification Process: | 2 mol/L NaOH | 50° C. | 90 seconds |
| Washing Process: | water | 30° C. | 45 seconds |
| Neutralization Process: | 10% by weight HCl | 30° C. | 45 seconds |
| Washing process: | water | 30° C. | 45 seconds |

Under the above conditions, saponification, washing, neutralization, and washing were sequentially carried out and subsequently, drying was carried out at 80° C.

### <Preparation of Polarizing Plate>

A 120 μm thick polyvinyl alcohol film was immersed in 100 kg of an aqueous solution incorporating 1 kg of iodine and 4 kg of boric acid, and was subsequently stretched at a factor of 6 at 50° C., whereby a polarizing film was prepared. The above samples, which had been subjected to the alkali saponification, were adhered to both sides of the resulting polarizing film, employing a 5% completely saponified type polyvinyl alcohol solution as an adhesive, whereby a polarizing plate was prepared.

### <Calculation of Polarization Degrees P0 and P500>

Polarization degree P0=[(H0′−H90′)/(H0′+H90)]½×100

Polarization degree P500=[(H0′−H90′)/(H0′+H90′)]½×100

Variation of polarization degree=P0−P500
P0: polarization degree prior to accelerated aging
P500: polarization degree after 500 hours of accelerated aging

### <Evaluation of Lightfastness>

The variation of polarization degree determined as above was evaluated based on the following criteria, whereby lightfastness was evaluated.
A: variation of polarization degree was less than 10%
B: variation of polarization degree was at least 10% but less than 25%
C: variation of polarization degree was at least 250

Table 2 shows the above results.

TABLE 2

| | | | | Variation | | | |
|---|---|---|---|---|---|---|---|
| | UV Absorbability | | | Coefficient | | | |
| Sample | 400 nm | 380 nm | Bleeding- | (CV) of | | Light- | |
| No. | Transmittance | Transmittance | Out | Retardation | Haze | fastness | Remarks |
| 1-1 | A | C | D | C | A | C | Comp. |
| 1-2 | A | B | C | B | A | B | Comp. |
| 1-3 | A | C | D | C | A | C | Comp. |
| 1-4 | A | B | C | B | A | B | Comp. |
| 1-5 | A | C | D | C | A | C | Comp. |
| 1-6 | A | B | C | B | A | B | Comp. |
| 1-7 | A | C | D | C | A | C | Comp. |
| 1-8 | A | A | C | B | A | B | Comp. |
| 1-9 | A | A | A | A | A | A | Inv. |
| 1-10 | A | A | A | A | A | A | Inv. |
| 1-11 | A | A | A | A | A | A | Inv. |
| 1-12 | A | A | A | B | B | A | Inv. |
| 1-13 | A | A | A | A | A | A | Inv. |
| 1-14 | A | A | A | A | A | A | Inv. |
| 1-15 | A | A | A | A | A | A | Inv. |
| 1-16 | A | A | A | A | A | A | Inv. |
| 1-17 | A | A | A | A | A | A | Inv. |
| 1-18 | A | A | A | A | A | A | Inv. |
| 1-19 | A | A | A | B | B | A | Inv. |
| 1-20 | A | A | A | A | A | A | Inv. |
| 1-21 | A | A | A | A | A | A | Inv. |
| 1-22 | A | A | A | A | A | A | Inv. |
| 1-23 | A | A | A | A | A | A | Inv. |
| 1-24 | A | A | A | A | A | A | Inv. |
| 1-25 | A | A | A | A | A | A | Inv. |
| 1-26 | A | A | A | A | A | A | Inv. |
| 1-27 | A | A | A | A | A | A | Inv. |
| 1-28 | A | A | A | A | A | A | Inv. |
| 1-29 | A | A | A | A | A | A | Inv. |
| 1-30 | A | A | A | A | A | A | Inv. |
| 1-31 | A | A | A | B | B | A | Inv. |
| 1-32 | A | A | A | A | A | A | Inv. |
| 1-33 | A | A | A | A | A | A | Inv. |
| 1-34 | A | A | A | A | A | A | Inv. |
| 1-35 | A | A | A | A | A | A | Inv. |

Comp.: Comparative Example,
Inv.: Present Invention

As can clearly be seen from Table 2, the optical cellulose ester film samples according to the present invention were superior to Comparative Examples in UV absorbability, haze characteristics, durability and light fastness.

### Example 2

Optical Cellulose Ester Film Samples 2-1 through 2-35 (all at a film thickness of 80 μm) were prepared in the same manner as Example 1, except that the types of cellulose esters, UV absorbers and various types of additives were changed as listed in Tables 3 and 4.

TABLE 3

| | |
|---|---|
| | KS-1 |
| 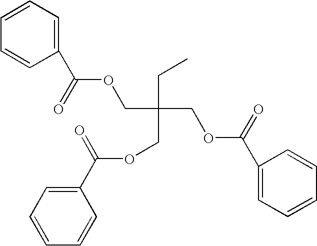 | |
| | KS-2 |
| 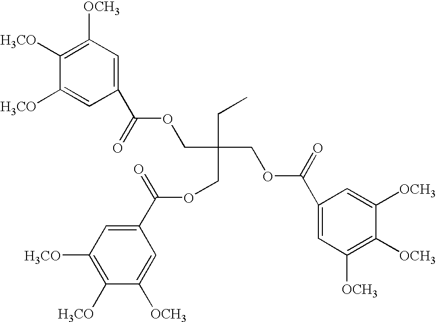 | |

| | | UV Absorber Added | Antioxidant 1 | Antioxidant 2 | Plasticizer | |
|---|---|---|---|---|---|---|
| Sample | Cellulose | Amount (weight | Added Amount | Added Amount | Added Amount | Re- |
| No. | Ester | parts) | (weight parts) | (weight parts) | (weight parts) | marks |
| 2-1 | C-1 | *1 (1.2) | IRGANOX 1010 (0.5) | — | KS-1 (15) | Comp. |
| 2-2 | C-1 | *2 (1.2) | IRGANOX 1010 (0.5) | — | triphenyl | Comp. |
| | | | | | phosphate (8) | |
| 2-3 | C-2 | *1 (1.2) | TINUVIN 144 (0.5) | — | KS-2 (15) | Comp. |
| 2-4 | C-2 | *2 (1.2) | TINUVIN 144 (0.5) | — | triphenyl | Comp. |
| | | | | | phosphate (8) | |
| 2-5 | C-3 | *1 (1.2) | SUMILIZER GP (3.0) | Irganox 1010 (0.5) | KS-1 (15) | Comp. |
| 2-6 | C-3 | *2 (1.2) | SUMILIZER GP (3.0) | Irganox 1010 (0.5) | KS-2 (15) | Comp. |
| 2-7 | C-4 | *1 (1.2) | SUMILIZER GP (3.0) | — | KS-1 (15) | Comp. |
| 2-8 | C-4 | *2 (1.2) | SUMILIZER GP (3.0) | — | triphenyl | Comp. |
| | | | | | phosphate (8) | |
| 2-9 | C-1 | 2 (1.2) | SUMILIZER GP (3.0) | Irganox 1010 (0.5) | KS-1 (15) | Inv. |
| 2-10 | C-1 | 3 (1.2) | SUMILIZER GP (3.0) | Irganox 1010 (0.5) | KS-2 (15) | Inv. |
| 2-11 | C-1 | 5 (1.2) | TINUVIN 144 (0.5) | — | KS-2 (15) | Inv. |
| 2-12 | C-1 | 22 (1.2) | TINUVIN 144 (0.5) | — | triphenyl | Inv. |
| | | | | | phosphate (8) | |
| 2-13 | C-1 | 28 (1.2) | IRGANOX 1010 (0.5) | — | KS-1 (15) | Inv. |
| 2-14 | C-1 | 32 (1.2) | IRGANOX 1010 (0.5) | — | KS-2 (15) | Inv. |
| 2-15 | C-2 | 2 (1.2) | SUMILIZER GP (3.0) | Irganox 1010 (0.5) | KS-1 (15) | Inv. |
| 2-16 | C-2 | 3 (1.2) | SUMILIZER GP (3.0) | Irganox 1010 (0.5) | KS-2 (15) | Inv. |
| 2-17 | C-2 | 18 (1.2) | TINUVIN 144 (0.5) | — | KS-2 (15) | Inv. |
| 2-18 | C-2 | 22 (1.2) | TINUVIN 144 (0.5) | — | triphenyl | Inv. |
| | | | | | phosphate (8) | |
| 2-19 | C-2 | 29 (1.2) | IRGANOX 1010 (0.5) | — | KS-1 (15) | Inv. |
| 2-20 | C-2 | 32 (1.2) | IRGANOX 1010 (0.5) | — | KS-2 (15) | Inv. |
| 2-21 | C-3 | 2 (1.2) | SUMILIZER GP (3.0) | Irganox 1010 (0.5) | KS-1 (15) | Inv. |
| 2-22 | C-3 | 3 (1.2) | SUMILIZER GP (3.0) | Irganox 1010 (0.5) | KS-2 (15) | Inv. |
| 2-23 | C-3 | 18 (1.2) | TINUVIN 144 (0.5) | — | KS-2 (15) | Inv. |
| 2-24 | C-3 | 21 (1.2) | TINUVIN 144 (0.5) | — | triphenyl | Inv. |
| | | | | | phosphate (8) | |
| 2-25 | C-3 | 25 (1.2) | IRGANOX 1010 (0.5) | — | KS-1 (15) | Inv. |
| 2-26 | C-3 | 29 (1.2) | IRGANOX 1010 (0.5) | — | KS-2 (15) | Inv. |
| 2-27 | C-4 | 2 (1.2) | SUMILIZER GP (3.0) | Irganox 1010 (0.5) | KS-1 (15) | Inv. |
| 2-28 | C-4 | 3 (1.2) | SUMILIZER GP (3.0) | Irganox 1010 (0.5) | KS-2 (15) | Inv. |
| 2-29 | C-4 | 8 (1.2) | TINUVIN 144 (0.5) | — | KS-2 (15) | Inv. |
| 2-30 | C-4 | 21 (1.2) | TINUVIN 144 (0.5) | — | triphenyl | Inv. |
| | | | | | phosphate (8) | |
| 2-31 | C-4 | 29 (1.2) | IRGANOX 1010 (0.5) | — | KS-1 (15) | Inv. |
| 2-32 | C-4 | 32 (1.2) | IRGANOX 1010 (0.5) | — | KS-2 (15) | Inv. |

*Comparative Compound,
Comp.: Comparative Example,
Inv.: Present Invention

TABLE 4

| | | UV | | | | |
|---|---|---|---|---|---|---|
| | | Absorber | | | Plasticizer | |
| | | Added | | | Added | |
| | | Amount | Antioxidant 1 | Antioxidant 2 | Amount | |
| Sample | Cellulose | (weight | Added Amount | Added Amount | (weight | |
| No. | Ester | parts) | (weight parts) | (weight parts) | parts) | Remarks |
| 2-33 | C-3 | 37 (1.2) | IRGANOX 1010 (0.5) | GSY-P101 (0.25) | KS-1 (8) | Present |
| | | | | | | Invention |
| 2-34 | C-3 | 39 (1.2) | IRGANOX 1010 (0.5) | GSY-P101 (0.25) | KS-1 (8) | Present |
| | | | | | | Invention |
| 2-35 | C-3 | 41 (1.2) | IRGANOX 1010 (0.5) | GSY-P101 (0.25) | KS-1 (8) | Present |
| | | | | | | Invention |

Prepared optical cellulose ester films were evaluated in the same manner as Example 1. Table 5 shows the results.

TABLE 5

| | | | | Variation | | | |
|---|---|---|---|---|---|---|---|
| | UV Absorbability | | | Coefficient | | | |
| Sample | 400 nm | 380 nm | Bleeding- | (CV) of | | Light- | |
| No. | Transmittance | Transmittance | Out | Retardation | Haze | fastness | Remarks |
| 2-1 | A | C | D | C | A | C | Comp. |
| 2-2 | A | B | C | B | A | B | Comp. |
| 2-3 | A | C | D | C | A | C | Comp. |
| 2-4 | A | B | C | B | A | B | Comp. |
| 2-5 | A | C | D | C | A | C | Comp. |
| 2-6 | A | B | C | B | A | B | Comp. |
| 2-7 | A | C | D | C | A | C | Comp. |
| 2-8 | A | B | D | B | A | C | Comp. |
| 2-9 | A | A | A | A | A | A | Inv. |
| 2-10 | A | A | A | A | A | A | Inv. |
| 2-11 | A | A | A | A | A | A | Inv. |
| 2-12 | A | A | A | B | A | A | Inv. |
| 2-13 | A | A | A | A | A | A | Inv. |
| 2-14 | A | A | A | A | A | A | Inv. |
| 2-15 | A | A | A | A | A | A | Inv. |
| 2-16 | A | A | A | A | A | A | Inv. |
| 2-17 | A | A | A | A | A | A | Inv. |
| 2-18 | A | A | A | A | A | A | Inv. |
| 2-19 | A | A | A | B | A | A | Inv. |
| 2-20 | A | A | A | A | A | A | Inv. |
| 2-21 | A | A | A | A | A | A | Inv. |
| 2-22 | A | A | A | A | A | A | Inv. |
| 2-23 | A | A | A | A | A | A | Inv. |
| 2-24 | A | A | A | A | A | A | Inv. |
| 2-25 | A | A | A | A | A | A | Inv. |
| 2-26 | A | A | A | A | A | A | Inv. |
| 2-27 | A | A | A | A | A | A | Inv. |
| 2-28 | A | A | A | A | A | A | Inv. |
| 2-29 | A | A | A | A | A | A | Inv. |
| 2-30 | A | A | A | A | A | A | Inv. |
| 2-31 | A | A | A | B | A | A | Inv. |
| 2-32 | A | A | A | A | A | A | Inv. |
| 2-33 | A | A | A | A | A | A | Inv. |
| 2-34 | A | A | A | A | A | A | Inv. |
| 2-35 | A | A | A | A | A | A | Inv. |

Comp.: Comparative Example,
Inv.: Present Invention

As can clearly be seen from Table 5, the optical cellulose ester film samples of the present invention which incorporated UV absorbers according to, the present invention were superior to Comparative Examples in UV absorbability, haze characteristics, durability and lightfastness.

### Example 3

Optical Cellulose Ester Film Samples (all at a film thickness of 80 μm) 3-1 through 3-35 were prepared in the same manner as Example 1, except that the type of cellulose esters, UV absorbers and various types of additives were changed as listed in Tables 6 and 7, followed by preparation of polarizing plates. Subsequently, polarizing plates of a commercial mobile devices (personal mobile tool ZAURUS Model Name M1-L₁, produced by Sharp Corp.) were carefully peeled away and each of the polarizing plates, prepared as above, was adhered to the liquid crystal display panel while matched with the polarized light direction.

TABLE 6

| | |
|---|---|
| | Comparative Compound 3 |
| 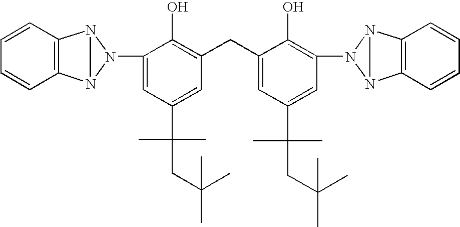 | |

| | | UV Absorber Added | Antioxidant 1 | Antioxidant 2 | Plasticizer | |
|---|---|---|---|---|---|---|
| Sample | Cellulose | Amount (weight | Added Amount | Added Amount | Added Amount | Re- |
| No. | Ester | parts) | (weight parts) | (weight parts) | (weight parts) | marks |
| 3-1 | C-1 | *1 (1.2) | IRGANOX 1010 (0.5) | — | KS-1 (15) | Comp. |
| 3-2 | C-1 | *2 (1.2) | IRGANOX 1010 (0.5) | — | triphenyl | Comp. |
| | | | | | phosphate (8) | |
| 3-3 | C-2 | *1 (1.2) | TINUVIN 144 (0.5) | — | KS-2 (15) | Comp. |
| 3-4 | C-2 | *3 (1.2) | TINUVIN 144 (0.5) | — | triphenyl | Comp. |
| | | | | | phosphate (8) | |
| 3-5 | C-3 | *2 (1.2) | SUMILIZER GP (3.0) | IRGANOX 1010 (0.5) | KS-1 (15) | Comp. |
| 3-6 | C-3 | *3 (1.2) | SUMILIZER GP (3.0) | IRGANOX 1010 (0.5) | KS-2 (15) | Comp. |
| 3-7 | C-4 | *1 (1.2) | SUMILIZER GP (3.0) | — | KS-1 (15) | Comp. |
| 3-8 | C-4 | *2 (1.2) | SUMILIZER GP (3.0) | — | triphenyl | Comp. |
| | | | | | phosphate (8) | |
| 3-9 | C-1 | 2 (1.2) | SUMILIZER GP (3.0) | IRGANOX 1010 (0.5) | KS-1 (15) | Inv. |
| 3-10 | C-1 | 3 (1.2) | SUMILIZER GP (3.0) | IRGANOX 1010 (0.5) | KS-2 (15) | Inv. |
| 3-11 | C-1 | 5 (1.2) | TINUVIN 144 (0.5) | — | KS-2 (15) | Inv. |
| 3-12 | C-1 | 22 (1.2) | TINUVIN 144 (0.5) | — | triphenyl | Inv. |
| | | | | | phosphate (8) | |
| 3-13 | C-1 | 28 (1.2) | IRGANOX 1010 (0.5) | — | KS-1 (15) | Inv. |
| 3-14 | C-1 | 32 (1.2) | IRGANOX 1010 (0.5) | — | KS-2 (15) | Inv. |
| 3-15 | C-2 | 2 (1.2) | SUMILIZER GP (3.0) | IRGANOX 1010 (0.5) | KS-1 (15) | Inv. |
| 3-16 | C-2 | 3 (1.2) | SUMILIZER GP (3.0) | IRGANOX 1010 (0.5) | KS-2 (15) | Inv. |
| 3-17 | C-2 | 18 (1.2) | TINUVIN 144 (0.5) | — | KS-2 (15) | Inv. |
| 3-18 | C-2 | 22 (1.2) | TINUVIN 144 (0.5) | — | triphenyl | Inv. |
| | | | | | phosphate (8) | |
| 3-19 | C-2 | 29 (1.2) | IRGANOX 1010 (0.5) | — | KS-1 (15) | Inv. |
| 3-20 | C-2 | 32 (1.2) | IRGANOX 1010 (0.5) | — | KS-2 (15) | Inv. |
| 3-21 | C-3 | 2 (1.2) | SUMILIZER GP (3.0) | IRGANOX 1010 (0.5) | KS-1 (15) | Inv. |
| 3-22 | C-3 | 3 (1.2) | SUMILIZER GP (3.0) | IRGANOX 1010 (0.5) | KS-2 (15) | Inv. |
| 3-23 | C-3 | 18 (1.2) | TINUVIN 144 (0.5) | — | KS-2 (15) | Inv. |
| 3-24 | C-3 | 21 (1.2) | TINUVIN 144 (0.5) | — | triphenyl | Inv. |
| | | | | | phosphate (8) | |
| 3-25 | C-3 | 25 (1.2) | IRGANOX 1010 (0.5) | — | KS-1 (15) | Inv. |
| 3-26 | C-3 | 29 (1.2) | IRGANOX 1010 (0.5) | — | KS-2 (15) | Inv. |
| 3-27 | C-4 | 2 (1.2) | SUMILIZER GP (3.0) | IRGANOX 1010 (0.5) | KS-1 (15) | Inv. |
| 3-28 | C-4 | 3 (1.2) | SUMILIZER GP (3.0) | IRGANOX 1010 (0.5) | KS-2 (15) | Inv. |
| 3-29 | C-4 | 8 (1.2) | TINUVIN 144 (0.5) | — | KS-2 (15) | Inv. |
| 3-30 | C-4 | 21 (1.2) | TINUVIN 144 (0.5) | — | triphenyl | Inv. |
| | | | | | phosphate (8) | |
| 3-31 | C-4 | 29 (1.2) | IRGANOX 1010 (0.5) | — | KS-1 (15) | Inv. |
| 3-32 | C-4 | 32 (1.2) | IRGANOX 1010 (0.5) | — | KS-2 (15) | Inv. |

*Comparative Compound,
Comp.: Comparative Example,
Inv.: Present Invention

TABLE 7

| | | UV | | | | |
|---|---|---|---|---|---|---|
| | | Absorber | | | Plasticizer | |
| | | Added | | | Added | |
| | | Amount | Antioxidant 1 | Antioxidant 2 | Amount | |
| Sample | Cellulose | (weight | Added Amount | Added Amount | (weight | |
| No. | Ester | parts) | (weight parts) | (weight parts) | parts) | Remarks |
| 3-33 | C-3 | 37 (1.2) | Irganox 1010 (0.5) | GSY-P101 (0.25) | KS-1 (8) | Present |
| | | | | | | Invention |
| 3-34 | C-3 | 39 (1.2) | Irganox 1010 (0.5) | GSY-P101 (0.25) | KS-1 (8) | Present |
| | | | | | | Invention |
| 3-35 | C-3 | 41 (1.2) | Irganox 1010 (0.5) | GSY-P101 (0.25) | KS-1 (8) | Present |
| | | | | | | Invention |

Contrast of each of the liquid crystal panels was visually evaluated. As a result, it was confirmed that liquid crystal panels employing the polarizing plate of the present invention were superior to the liquid crystal panels employing the polarizing plate of Comparative Examples since high contrast was maintained over an extended period, no unnatural yellowing resulted, and color reproduction was excellent.

1. A cellulose ester film for optical use comprising at least one compound represented by Formulae 1, 2 or 3: 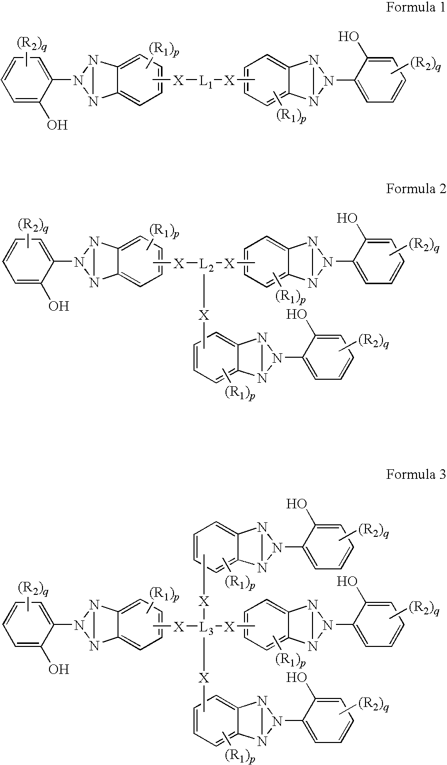
in Formulae 1 to 3, R₁ and R₂ each are a substituent; X is —COO—, —OCO—, NR₁₁CO—, —CONR₁₁—, —O—, —NR₁₂R₁₃—, —SO₂NR₁₄—, —NR₁₄SO₂—, —S—, or —SO₂—; L₁ is a divalent linking group; L₂ is a trivalent linking group; L₃ is a tetravalent linking group; R₁₁, R₁₂, R₁₃ and R₁₄ each are a hydrogen atom, an alkyl group, or an aryl group; p is an integer of 0 to 3; and q is an integer of 0 to 4.

2. The cellulose ester film of claim 1, wherein the compound represented by Formulae 1, 2 or 3 is further represented by Formulae 4, 5 or 6, respectively: 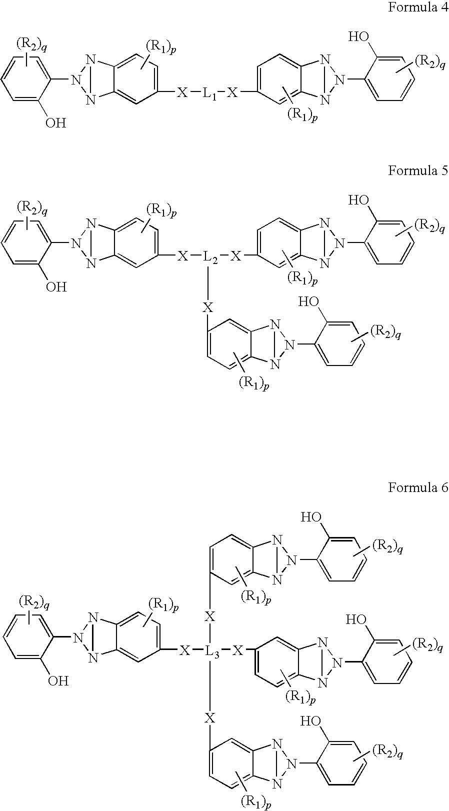
in Formulae 4 to 6, R₁ and R₂ each are a substituent; X is —COO—, —OCO—, NR₁₁CO—, —CONR₁₁—, —O—, —NR₁₂R₁₃—, —SO₂ NR₁₄—, —NR₁₄SO₂—, —S—, or —SO₂—; L₁ is a divalent linking group; L₂ is a trivalent linking group; L₃ is a tetravalent linking group; R₁₁, R₁₂, R₁₃ and R₁₄ each are a hydrogen atom, an alkyl group or an aryl group; p is an integer of 0 to 3; and q is an integer of 0 to 4.

3. The cellulose ester film of claim 1, wherein X in Formulae 1 to 6 is —COO—, —OCO—, NR₁₁CO—, or —CONR₁₁—, provided that R₁₁ is a hydrogen atom, an alkyl group or an aryl group.

4. The cellulose ester film of claim 2, wherein the compound presented by Formula 1 is further represented by Formula 4.

5. The cellulose ester film of claim 4, wherein X in Formula 4 is —COO—, —OCO—, NR₁₁CO—, or —CONR₁₁—, provided that R₁₁ is a hydrogen atom, an alkyl group or an aryl group.

6. The cellulose ester film of claim 1, in Formulae 1 to 5, L₁, L₂ and L₃ each are a linking group comprising an ether bond.

7. The polarizing plate comprising the cellulose ester film of claim 1.

8. The liquid crystal display comprising the cellulose ester film of claim 1.
